(19) United States
(12) Patent Application Publication
(10) Pub. No.: US 2025/0116836 A1
(43) Pub. Date: Apr. 10, 2025

(54) CABLE FIXATION DEVICES AND ARRANGEMENTS WITH IMPROVED FIXATION FEATURES FOR TELECOMMUNICATIONS ENCLOSURES

(71) Applicant: CommScope Technologies LLC, Hickory, NC (US)

(72) Inventors: Eddy Luc CAMS, Bilzen (BE); Philippe COENGRACHT, Hasselt (BE); Els TIMMERMANS, Wilsele (BE); Matthew CAMPSTEYN, Hoeselt (BE); Olivier C. ROCHE, Schaerbeek (BE); Nancy Roza VAN DIJCK, Wezemaal (BE)

(73) Assignee: CommScope Technologies LLC, Hickory, NC (US)

(21) Appl. No.: 18/294,610

(22) PCT Filed: Aug. 9, 2022
(86) PCT No.: PCT/US2022/039870

§ 371 Date: Feb. 2, 2024

Related U.S. Application Data
(60) Provisional application No. 63/231,419, filed on Aug. 10, 2021.
(60) Provisional application No. 63/336,339, filed on Apr. 29, 2022.
(60) Provisional application No. 63/323,579, filed on Mar. 25, 2022.

(51) Int. Cl. G02B 6/44

(52) U.S. Cl. CPC G02B 6/4471

(57) ABSTRACT

Devices, arrangements and methods for fixing components of telecommunications cables relative to a telecommunications closure. Features of the devices and arrangements can improve installability, maintenance and handling of different types of telecommunications cables and optical fibers at a telecommunications closures.

### CROSS-REFERENCE TO RELATED APPLICATIONS

This application is being filed on Aug. 9, 2022 as a PCT International Patent Application and claims the benefit of U.S. Patent Application Ser. No. 63/231,419, filed on Aug. 10, 2021, claims the benefit of U.S. Patent Application Ser. No. 63/323,579, filed on Mar. 25, 2022 and claims the benefit of U.S. Patent Application Ser. No. 63/336,339, filed on Apr. 29, 2022, the disclosures of which are incorporated herein by reference in their entireties.

### TECHNICAL FIELD

The present disclosure relates to telecommunications enclosures, and more particularly to devices and arrangements for fixing portions of telecommunications cables to telecommunications enclosures.

### BACKGROUND

Telecommunications systems typically employ a network of telecommunications cables capable of transmitting large volumes of data and voice signals over relatively long distances. Telecommunications cables can include fiber optic cables, electrical cables, or combinations of electrical and fiber optic cables. A typical telecommunications network also includes a plurality of telecommunications enclosures integrated throughout the network of telecommunications cables. The telecommunications enclosures or “closures” are adapted to house and protect telecommunications components such as optical fibers, fiber splices, termination panels, power splitters, wave division multiplexers, fiber management trays, cable organizing and routing components, etc.

Typically, cables holding optical fibers entering telecommunications enclosures must be fixed in place inside the enclosure. Within the closure, and depending on the type of cable, protective components of the cable, such as a jacket, a buffer tube, strength members, etc., are stripped, truncated, or removed, allowing the optical fibers held by the cable to be managed (e.g., routed, split, spliced, stored) within the closure.

### SUMMARY

In general terms, the present disclosure is directed to improvements in telecommunications cable management and, more particularly, in telecommunications closures and in fixation of cables at telecommunications closures.

Devices and arrangements according to the present disclosure can facilitate installation of cable fixation components at telecommunications closures.

Devices and arrangements according to the present disclosure can improve fixation of cable fixation components.

Devices and arrangements according to the present disclosure can improve versatility of telecommunications cable closure organizers in accommodating differently configured cable fixation assemblies and devices.

A given telecommunications closure is configured to route fibers from one or more provider side telecommunications cables to one or more subscriber side telecommunications cables. For example, telecommunications closures can route fibers from incoming feeder cables to outgoing drop cables, from incoming feeder cables to outgoing branch cables, from incoming branch cables to outgoing branch cables, and so forth. The cables enter the closure, typically through sealed ports defined by the closure, and the fibers of those cables are then managed within the interior volume of the closure by a technician. Fiber management can include, for example, fiber storage (typically in loops or portions of loops), splicing, splitting, wave division multiplexing, indexing, and so forth.

A given telecommunications closure can support one or more of: feeder cables, branch cables, connectorized and non-connectorized drop (or distribution) cables, loose fibers, fiber ribbons, etc. Some cables that enter a telecommunications closure include rigid strength rods that must be fixed relative to the closure. Some cables that enter a telecommunications closure include strength yarn, e.g., made from aramid fibers, that must be fixed relative to the closure. Some fibers are spliced to other fibers at splices that are supported within the closure. The optical fibers of connectorized drop cables are terminated at optical fiber connectors. The connectors at some drop cables can be connected to other connectorized fibers at panels (or banks) of adapters mounted within the closure.

The portions of the cables that enter the closure through the closure ports are typically jacketed with outer protective jackets. Seal blocks positioned at the cable ports seal around the outer jackets of the cables. For feeder and drop cables, the bare fibers are exposed within the closure by stripping the outer jacket, and a remaining end portion of the outer jacket is fixed to cable fixation assemblies within the closure. Exposed aramid yarn and/or rigid strength rods of such cables are also anchored within the closure, often to the same cable fixation assembly as the outer jacket. Fixation of cables and strength members relative to the closure can help to avoid fiber breakage and disruption of the closure seal due to lateral loads on the cables.

Different regions of a closure volume can be set up for different types of cable fixation and fiber management. For example, a closure can include a main support structure that can support feeder cable fixation on one side of the structure and connectorized and non-connectorized drop cables on the opposite side. However, it may be advantageous in certain applications to e.g., use the feeder cable fixation side of the main support structure for additional drop cables or other cables of generally smaller maximum transverse diameter than feeder cables. Aspects of the present disclosure include devices and arrangements that can provide such versatility in use of the main support structure.

The contents of International PCT Publication No. WO2020/154418 filed Jan. 22, 2020 and International PCT Application No. PCT/US2021/017678 filed Feb. 11, 2021 are hereby incorporated by reference in their entireties.

In accordance with certain specific aspects of the present disclosure, an assembly for an organizer of a telecommunications closure includes: a main support structure defining back-to-back first and second fixation surfaces, the first cable fixation surface being configured to directly mount a main body of a fixation assembly for a feeder cable, the main body including a cable jacket fixation portion; a first baseplate, the first baseplate being configured to directly mount to the first cable fixation surface, the first baseplate being configured to directly mount a fixation assembly of a drop cable having a smaller maximum transverse diameter than a maximum transverse diameter of the feeder cable; and a second baseplate configured differently from the first baseplate, the second baseplate being configured to directly mount to the second cable fixation surface, the second baseplate being configured to directly mount the fixation assembly of the drop cable.

In accordance with further aspects of the present disclosure, an assembly for an organizer of a telecommunications closure includes: a main body, the main body extending from a proximal end to a distal end along an axis defined by the main body, the main body including a cable jacket fixation portion, the cable jacket fixation portion including a shoulder defining a proximally facing surface configured to engage a distal end of an outer jacket of a cable when the cable is being secured to the cable jacket fixation portion with a longitudinal axis of the cable parallel to the axis defined by the main body.

In accordance with further aspects of the present disclosure, an assembly for an organizer of a telecommunications closure includes: a main body, the main body extending from a proximal end to a distal end along an axis defined by the main body, the main body including a cable jacket fixation portion and a strength rod fixation portion; and a strength member fixation subassembly, the main body defining a track, the subassembly being configured to slidably engage the track in a direction perpendicular to the axis, the main body further comprising a lip positioned at an open end of the track, the lip being configured to inhibit disengagement of the subassembly from the track.

In accordance with further aspects of the present disclosure, an assembly for an organizer of a telecommunications closure includes: a main body, the main body extending from a proximal end to a distal end along an axis defined by the main body, the main body including a cable jacket fixation portion, the cable jacket fixation portion defining a pocket configured to receive and retain overlength of a strap of a cable clamp used to clamp a cable jacket to the cable jacket fixation portion.

In accordance with further aspects of the present disclosure, an assembly for an organizer of a telecommunications closure includes: a main body, the main body extending from a proximal end to a distal end along an axis defined by the main body, the main body including a cable jacket fixation portion and an arrangement of posts and a notch for winding strength yarn of a cable, each of the posts projecting from a fixed end of the post to a free end of the post, the notch being located in an arm of a cable jacket support structure of the cable jacket fixation portion.

In accordance with further aspects of the present disclosure, a method includes: providing a main body extending from a proximal end to a distal end along an axis defined by the main body, the main body including a cable jacket fixation portion and a strength yarn winding arrangement, the arrangement including a post and a notch, the notch being located in an arm of a cable jacket support structure of the cable jacket fixation portion; grasping strength yarn of a telecommunications cable; and wrapping the yarn about the arrangement, including: routing the yarn about the post, followed by; routing the yarn through the notch; and after the wrapping, clamping a remainder of the yarn and the cable to the main body with a cable clamp.

In accordance with still further aspects of the present disclosure, a method includes: providing a main body extending from a proximal end to a distal end along an axis defined by the main body, the main body including a cable jacket fixation portion and a strength yarn winding arrangement, the arrangement including a first post, a second post, a third post, a fourth post, and a notch, the notch being located in an arm of a cable jacket support structure of the cable jacket fixation portion; grasping strength yarn of a telecommunications cable; and wrapping the yarn about the arrangement, including: routing the yarn in front of the first post, followed by; routing the yarn behind the second post, followed by; routing the yarn behind the third post, followed by; routing the yarn behind the fourth post, followed by; routing the yarn behind the second post, followed by: routing the yarn behind the first post, followed by; routing the yarn through the notch; and after the wrapping, clamping a remainder of the yarn and the cable to the main body with a cable clamp.

In accordance with still further aspects of the present disclosure, a module retainer for retaining a cable fixation module relative to a main support structure of an organizer of a telecommunications closure, includes: a body configured to snappingly mount to the main support structure; and a first flexibly resilient arm extending from the body to a free end of the first flexibly resilient arm.

According to further aspects of the present disclosure, an assembly for an organizer of a telecommunications closure, includes: a main body, the main body extending from a proximal end to a distal end along an axis defined by the main body, the main body including a cable jacket fixation portion for fixing a portion of a cable jacket; and a jacket support that slidingly engages with the main body perpendicular to the axis to adjustably clamp to the cable jacket.

According to further aspects of the present disclosure, an assembly for an organizer of a telecommunications closure, includes: a main body, the main body extending from a proximal end to a distal end along an axis defined by the main body, the main body including a cable jacket fixation portion for fixing a portion of a cable jacket; a clamp piece pivotally mounted to the main body; and another clamp piece pivotally mounted to the main body and aligned with and opposing the clamp piece, the clamp piece and the another clamp piece being configured to pivot toward and away from each other to adjustably clamp to the cable jacket.

According to further aspects of the present disclosure, an assembly for an organizer of a telecommunications closure, includes: a main body, the main body extending from a proximal end to a distal end along an axis defined by the main body, the main body including a cable jacket fixation portion for fixing a portion of a cable jacket; a threaded fastener; and a threaded retainer, the main body being configured to be secured to a receiver of the closure by inserting the fastener through the main body and threading the fastener through the retainer to cause a portion of the main body to be clamped between the retainer and a projecting structure of the receiver.

According to further aspects of the present disclosure, an assembly for an organizer of a telecommunications closure, includes: a main body, the main body extending from a proximal end to a distal end along an axis defined by the main body, the main body including a cable jacket fixation portion for fixing a cable jacket and a strength rod fixation portion positioned distally of the cable jacket fixation portion for fixing a cable strength rod, wherein the strength rod fixation portion extends distally beyond a distal extreme of the main body, such that the main body defines material voids on three sides of the strength rod fixation portion.

According to further aspects of the present disclosure, an assembly for an organizer of a telecommunications closure, includes: a main body, the main body extending from a proximal end to a distal end along an axis defined by the main body, the main body including a cable jacket fixation portion for fixing a cable jacket and a strength rod fixation portion positioned distally of the cable jacket fixation portion for fixing a cable strength rod, wherein the strength rod fixation portion includes multiple tracks defining at least a proximal location and a distal location positioned distally of the proximal location to which a strength member fixation subassembly can be slidably mounted.

According to further aspects of the present disclosure, a method includes: fixing a jacket of a cable carrying an optical fiber to a cable jacket fixation body; fixing the cable jacket fixation body to a baseplate and, thereafter; mounting the baseplate to a surface of an assembly of a telecommunications closure, including bending the baseplate into a bent configuration and, while the baseplate is in the bent configuration, sliding the baseplate relative to the surface, such that mounting features of the baseplate engage mounting features projecting from the surface; and releasing the baseplate such that the baseplate resiliently returns to an unbent configuration, thereby installing the baseplate on the assembly.

According to further aspects of the present disclosure, a method includes: fixing a jacket of a cable carrying an optical fiber to a cable jacket fixation body; mounting the cable jacket fixation body to a surface of a carrier adapter; mounting a retainer to the carrier adapter, the retainer including a retainer body and a flexibly resilient arm extending from the retainer body to a free end of the flexibly resilient arm such that the retainer arm prevents disengagement of the cable jacket fixation body from the surface of the carrier adapter and, thereafter; mounting the carrier adapter to a receiver of an assembly of a telecommunications closure.

According to further aspects of the present disclosure, an assembly for an organizer of a telecommunications closure, includes: a carrier adapter, the carrier adapter configured to receive a cable jacket fixation body and further configured to mount in a receiver of an assembly of a telecommunications closure; and a retainer, the retainer including a retainer body and a flexibly resilient arm extending from the retainer body to a free end of the flexibly resilient arm, the retainer body being configured to snap-connect to the carrier adapter such that the retainer arm prevents disengagement of the cable jacket fixation body from the surface of the carrier adapter.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a perspective view of a telecommunications closure in accordance with the present disclosure, the closure being in a closed configuration.

FIG. 2 is a perspective view of the housing pieces of the closure of FIG. 1.

FIG. 3 is a bottom perspective view of a cable organizer in accordance with the present disclosure, including a feeder cable, a drop cable, a feeder cable fixation assembly, and a drop cable fixation assembly.

FIG. 4 is a further bottom perspective view of the organizer of FIG. 3.

FIG. 5 is an enlarged, bottom perspective view of a portion of the organizer of FIG. 3.

FIG. 6 is a further bottom perspective enlarged view of a portion of the organizer of FIG. 3.

FIG. 7 is a top perspective view of the cable organizer of FIG. 3.

FIG. 8 is an enlarged, top perspective view of the called-out portion A of FIG. 7.

FIG. 9 is a further, top perspective view of the cable organizer of FIG. 3.

FIG. 10 is a further enlarged, top perspective view of the called-out portion B of FIG. 9.

FIG. 11 is a top, planar view of the cable organizer of FIG. 3.

FIG. 12 is a cross-sectional perspective view of a portion of the cable organizer of FIG. 3 along the line C-C in FIG. 11.

FIG. 13 is a perspective view of a drop cable fixation baseplate of the cable organizer of FIG. 11.

FIG. 14 is a further perspective view of the baseplate of FIG. 13.

FIG. 15 is a bottom perspective view of a portion of the cable organizer of FIG. 3.

FIG. 16 is a partially exploded view of the organizer portion of FIG. 15.

FIG. 17 is a perspective view of a feeder cable fixation baseplate of the cable organizer of FIG. 11.

FIG. 18 is a further perspective view of the baseplate of FIG. 17.

FIG. 19 is a bottom, planar view of the cable organizer portion of FIG. 15.

FIG. 20 is a cross-sectional perspective view of a portion of the organizer portion of FIG. 15 along the line D-D in FIG. 19, during an installation operation of the drop cable fixation subassembly to the feeder cable side drop cable fixation baseplate of FIG. 17.

FIG. 21 is a cross-sectional perspective view of a portion of the organizer portion of FIG. 15 along the line D-D in FIG. 19, following completed installation of the drop cable fixation subassembly to the feeder cable side drop cable fixation baseplate of FIG. 17.

FIG. 22 is a partially exploded view of a portion of the organizer of FIG. 3.

FIG. 23 is a perspective view of the feeder cable assembly of the organizer portion of FIG. 22.

FIG. 24 is an exploded, perspective view of the feeder cable assembly of FIG. 23.

FIG. 25 is a further exploded, perspective view of the feeder cable assembly of FIG. 23.

FIG. 26 is a perspective view of the main body of the feeder cable assembly of FIG. 23.

FIG. 27 is an enlarged view of a portion of the main body of FIG. 26.

FIG. 28 is a further view of the portion of FIG. 27, including a portion of a cable strap.

FIG. 29 is a perspective view of a portion of the feeder cable assembly of FIG. 23.

FIG. 30 is a further perspective view of the feeder cable assembly of FIG. 23, and illustrating an example routing of strength yarn of the feeder cable.

FIG. 31 is a further perspective view of the feeder cable assembly of FIG. 23, further illustrating the example strength yarn routing of FIG. 30.

FIG. 32 is a bottom, planar view of the organizer of FIG. 3.

FIG. 33 is a cross-sectional, perspective view of a portion of the organizer of FIG. 3 along the line E-E in FIG. 32, and illustrating the feeder cable main body retainer arm in a retaining position.

FIG. 34 is a cross-sectional, perspective view of a portion of the organizer of FIG. 3 along the line E-E in FIG. 32, and illustrating the feeder cable main body retainer arm in an installation and/or removal position.

FIG. 35 is a bottom, planar view of a portion of the organizer of FIG. 3.

FIG. 36 is a cross-sectional, perspective view of a portion of the organizer portion of FIG. 34, along the F-F in FIG. 35.

FIG. 37 is a bottom, planar view of the organizer of FIG. 3.

FIG. 38 is a cross-sectional, perspective view of a portion of the organizer of FIG. 3 along the line G-G in FIG. 37.

FIG. 39 is an enlarged, perspective view of a portion of the organizer of FIG. 3, illustrating the module retainer installed to the main support structure.

FIG. 40 is an enlarged, perspective view of the organizer portion of FIG. 38, with the module retainer removed.

FIG. 41 is a perspective view of the module retainer of FIG. 38.

FIG. 42 is a further perspective view of the module retainer of FIG. 38.

FIG. 43 is a perspective view of further example telecommunications equipment to which cables can be affixed according to the present disclosure.

FIG. 44 is a perspective view of the base assembly of the equipment of FIG. 43.

FIG. 45 is a further perspective view of the base assembly of FIG. 44.

FIG. 46 is a perspective cross-sectional view of a portion of the base assembly of FIG. 44.

FIG. 47 is a perspective view of a further example cable fixation assembly according to the present disclosure.

FIG. 48 is an exploded view of the assembly of FIG. 47.

FIG. 49 is a perspective view of a further example cable fixation assembly according to the present disclosure.

FIG. 50 is an exploded view of the assembly of FIG. 49.

FIG. 51 is a perspective view of a further example cable fixation assembly according to the present disclosure.

FIG. 52 is a perspective view of a further example cable fixation assembly according to the present disclosure.

FIG. 53 a perspective view of the strength member clamp body of the assembly of FIG. 52.

FIG. 54 is a further perspective view of the strength member clamp body of FIG. 53.

FIG. 55 is a perspective view of a further example cable fixation assembly according to the present disclosure.

FIG. 56 a perspective view of the strength member clamp body of the assembly of FIG. 55.

FIG. 57 is a further perspective view of the strength member clamp body of FIG. 53.

FIG. 58 is a further perspective view of the assembly of FIG. 47.

FIG. 59 is a perspective view of a subassembly of a carrier adapter and a module retainer of the base assembly of FIG. 44.

FIG. 60 is an exploded view of the subassembly of FIG. 59.

FIG. 61 is a further exploded view of the subassembly of FIG. 59.

FIG. 62 is a further exploded view of the subassembly of FIG. 59.

FIG. 63 is a perspective view of a portion of the assembly of FIG. 44.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

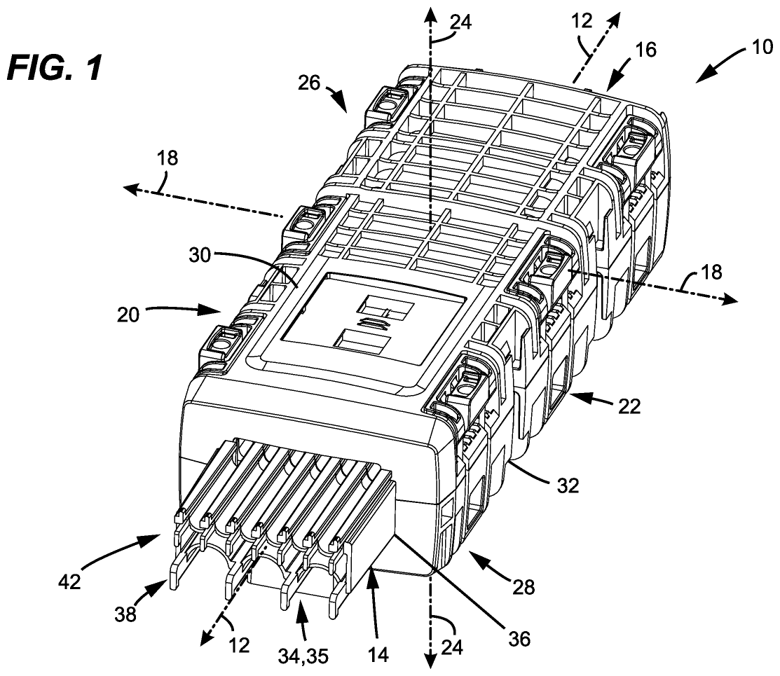

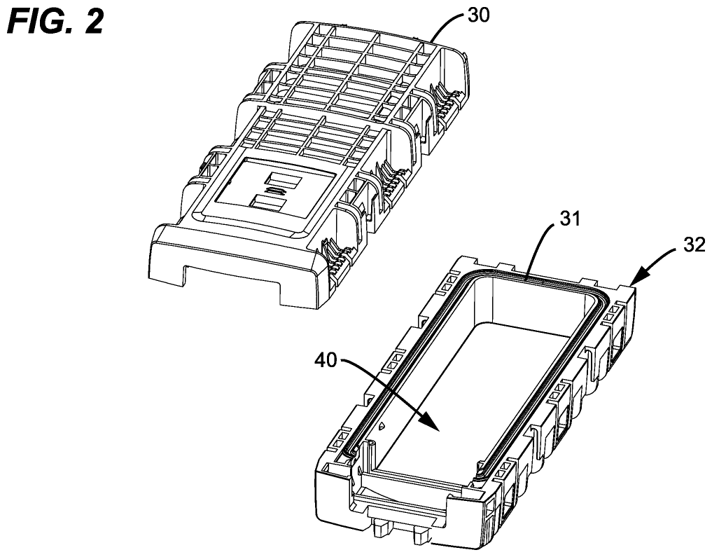

Referring to FIGS. 1-2, a telecommunications closure 10 extends along a longitudinal axis 12 between a proximal end 14 and a distal end 16. The closure 10 extends along a transverse axis 18 between a first side 20 and a second side 22. The closure 10 extends along a vertical axis 24 between a top 26 and a bottom 28. The axes 12, 18 and 24 are mutually perpendicular, with the axes 12 and 18 defining a horizontal plane.

As used herein, terms such as proximal, distal, top, bottom, upper, lower, vertical, horizontal and so forth will be used with reference to the axes 12, 18, and 24 of FIG. 1 and in relating the positions of one component to another with respect to the full closure assembly of FIG. 1. These relative terms are for ease of description only, and do not limit how the closure 10 or any individual component or combination of components, may be oriented in practice.

The closure 10 includes a first upper housing piece 30 and a second lower housing piece 32 that cooperate (e.g., with hinges, clamps, etc.) to form a sealable and re-enterable closure volume 40. A perimeter seal element 31 forms a seal about three sides of the closure volume 40 when the closure 10 is in a sealed and closed configuration.

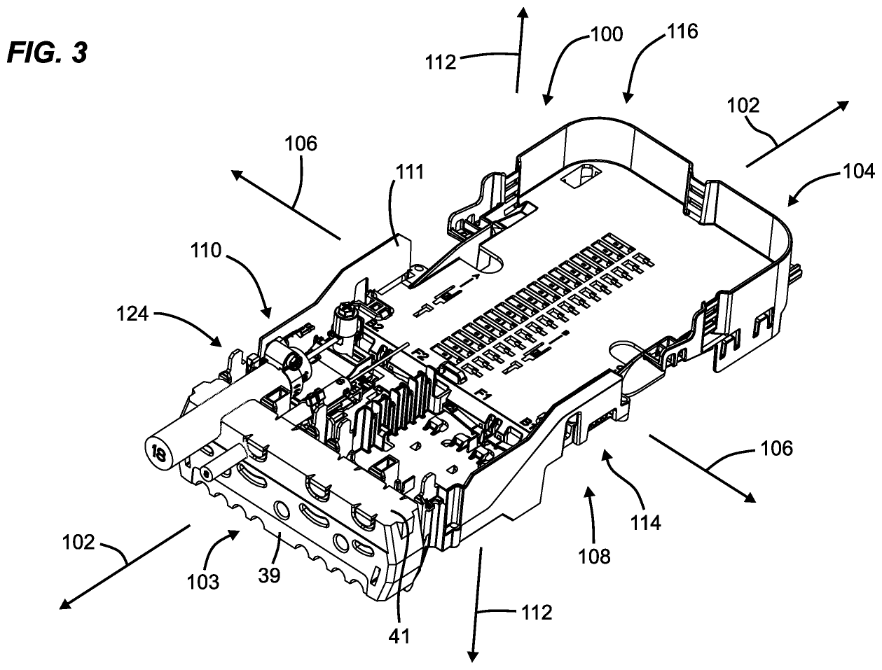

The closure volume 40 is configured to house a cable organizer 34. An internal portion (not shown in FIGS. 1-2) of the cable organizer 34 is positioned within the closure volume 40. An external portion 35 of the cable organizer 34 is positioned exterior to the closure volume 40, with the cable organizer 34 extending through a proximally positioned opening 36 defined between the proximal ends of the first and second housing pieces 30 and 32. Cables enter the closure volume 40 via the opening 36 and sealed cable ports defined by cable sealing bodies 39, 41 (FIG. 3) positioned at the opening 36 and mounted as part of the internal portion of the cable organizer 34.

The cable organizer 34 is configured to accommodate relatively thick cables (such as feeder cables) entering the closure 10 via a lower portion 38 of the cable organizer 34, and relatively thin cables (such as drop cables) entering the closure via an upper portion 42 of the cable organizer 34. However, as described above and in more detail below, aspects of the present disclosure relate to adapting the lower portion 38 of the cable organizer 34 to accommodate thinner cables, such as drop cables.

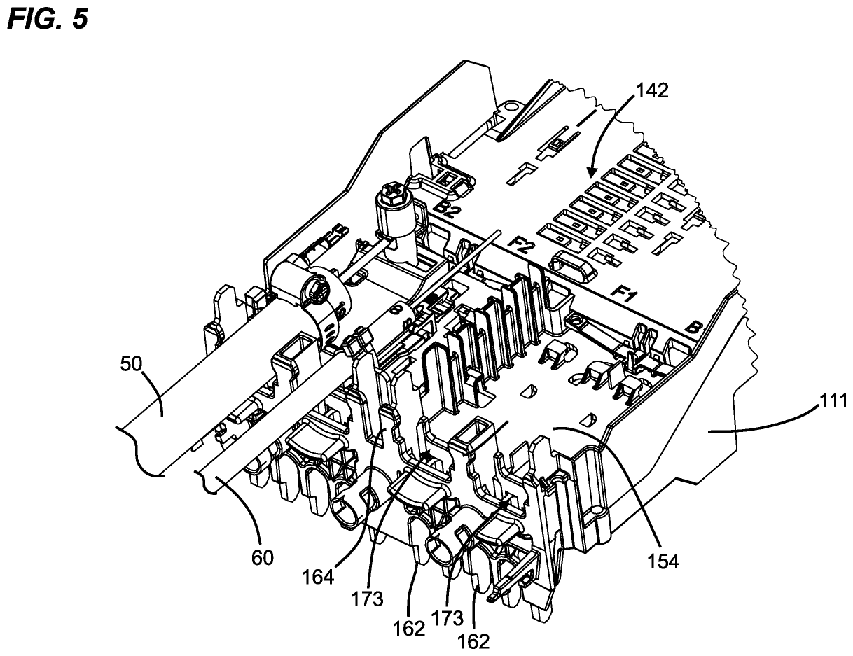

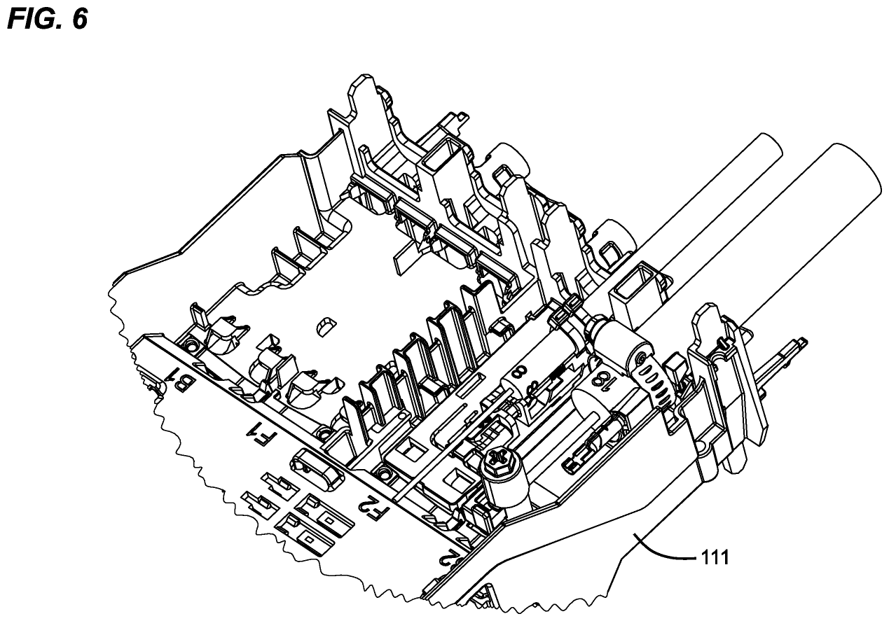

Referring now to FIGS. 3-8, a cable organizer (or organizer) 100 in accordance with the present disclosure will be described. The cable organizer 100 can cooperate with housing pieces of a closure such as described above. For example, the cable organizer 100 can cooperate with the housing pieces 30, 32 as described above with respect to FIGS. 1 and 2, an internal portion of the organizer being positioned in the closure volume 40. Other than at the proximal side, the housing pieces 30 and 32 do not form another opening to the outside of the closure.

The organizer 100 extends along a longitudinal axis 102 from a proximal end 103 to a distal end 104, along a transverse axis 106 from a first side 108 to a second side 110, and along a vertical axis 112 from a top 114 to a bottom 116. The axes 102, 106 and 112 are mutually perpendicular, with the axes 102 and 106 defining a horizontal plane. The organizer 100 includes the seal blocks 39 and 41.

The organizer 100 is generally divided by one or more panels, walls, or other structures between an upper portion 122 and a lower portion 124. Some of these panels, walls and other structures form an integrated unit that serves as a main support structure 111 of the organizer 100. In some examples, the internal portion of the organizer 100 corresponds to the main support structure 111, and the external portion (e.g., the external portion 35 (FIG. 1) is coupled to the main support structure 111. The organizer 100 defines one or more channels and other guiding structures (e.g., structures that define pathways 144) for guiding optical fibers between the upper and lower portions, such that an optical fiber from a cable (e.g., a feeder cable) fixed in the lower portion can be optically coupled to an optical fiber of a cable (e.g., a drop cable) fixed in the upper portion. In addition, fibers can be routed from one cable to another cable entering the closure on the same side of the main support structure 111, e.g., from a feeder cable entering the closure on the lower side to a drop cable entering the closure on the lower side.

The main support structure 111 can be constructed (e.g., molded) of a polymeric material, or machined from metal (e.g., sheet metal). The main support structure 111 includes in the upper portion 122 a cable fixation region 126 and a fiber management region 128 positioned distally from the cable fixation region 126. The main support structure 111 also includes in the lower portion 124 a cable fixation region 130 and a fiber management region 132 positioned distally from the cable fixation region 130. The cable fixation regions 126 and 130 are generally vertically aligned. The fiber management regions 128 and 132 are generally vertically aligned.

The lower fiber management region 132 is partially defined by a side wall 134 and a horizontal downward facing surface 136 of a panel 138, together forming a basket. The basket of the lower fiber management region 132 can serve as a storage area for looped fiber from feeder cables 50, such as the feeder cable 50. The looped fiber can be in the form of loose fibers, loose fibers protected in groups by a common sheath, fiber ribbons, etc. Fibers can be guided from the lower fiber management region 132 to the upper fiber management region where they can be further managed, e.g., with splices, connectors and adapters, splitters, wave division multiplexors, etc.

The upper fiber management region 128 includes an upward facing horizontal surface 140 of the panel 138. The surfaces 136, 140 define mounting structures 142 for mounting optical fiber management components, such as splitter holders and/or splice holders. Fiber retainers 146 are also provided in the upper fiber management region 128 and retain fibers extending from cables 50, 60 within the upper fiber management region 128 while enabling compliance with bend radius limitations of the optical fibers.

In some examples, the upper fiber management region includes one or more banks of fiber optic adapters (not shown) that can be used to optically connect connectorized fibers of drop cables having connectors with connectorized fibers of other cables.

In some examples, non-connectorized drop cables can be fixed in the upper cable fixation region 126 and their fibers managed in the upper fiber management region 128. Thus, the upper fiber management region of the organizer 100 can accommodate connectorized drop cables, non-connectorized drop cables, or a combination of connectorized and non-connectorized drop cables. Other cable types and configurations can also be accommodated and managed at the cable fixation region 126. In alternative examples, the adapters, or non-functional receptacles that behave like one-sided adapters, can serve as parking or storage for the connectors terminating optical fibers.

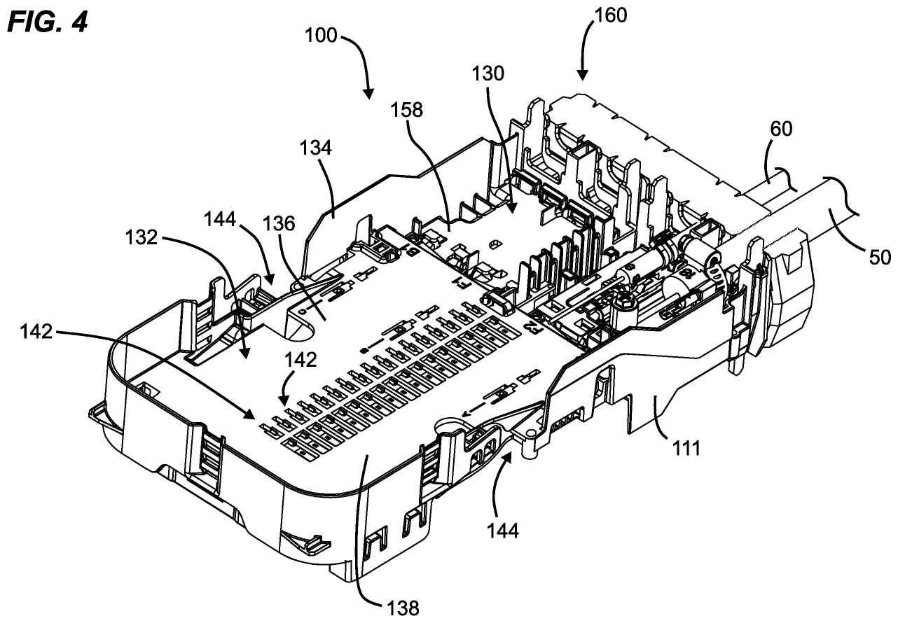

The upper cable fixation region 126 and the lower cable fixation region 130 are separated by a wall 154 of the main support structure 111. The wall includes an upward facing horizontal surface 156 and a downward facing horizontal surface 158 (FIGS. 8 and 4). The surfaces 156 and 158 are back-to-back and can support cable fixation assemblies as will be described in greater detail below.

Positioned proximally of the cable fixation regions 126 and 130 is a seal region 160 of the organizer 100. The seal region 160 includes a plurality of dividers 162 and 164 in the upper portion 122 and the lower portion 124, respectively, of the organizer 100. The dividers 162 define openings 166 through which connectorized drop cables 60 and non-connectorized drop cables (or other types of cables) enter the closure. The dividers 164 define openings 173 through which feeder cables 50 or the types of cables (e.g., drop cables 60) enter the closure. The dividers 162 and 164 are provided in two rows in the upper portion 122 spaced apart longitudinally from each other and two rows and in the lower portion 124 spaced apart longitudinally from each other. In the space between rows of dividers there are placed seal blocks 39 and 41. The seal blocks 39 and 41 form seals around the cables entering the closure. The seal blocks also serve to seal off the proximal opening of the closure defined between the housing pieces of the closure.

The cable fixation regions 126 and 130 are used to fix cables entering the closure through ports defined by seal blocks between the dividers 162 and 164, respectively. For illustrative purposes, the fixed cables shown include a feeder cable 50 and a drop cable 60 both entering the cable fixation region 130. In some examples, optical signals can be routed from the feeder cable 50 to the drop cable 60 via the organizer 100, even though the cables 50 and 60 enter the closure on the same side of the organizer 100. It should be appreciated that the number and type of cables extending through cable ports into the closure can depend on the particular fiber management needs of the closure. In some examples, one or more of the ports can be plugged and not receive any cable. Whatever the configuration of cables entering the cable ports at the cable fixation regions 126, 130, those cables must be affixed in the cable fixation region 126, 130 to minimize unwanted movement of the cables, which can damage optical fibers and other structures in the closure volume.

Various features of cable fixation assemblies for affixing the cables at the fixation regions 126 and 130 will now be described.

Three example cable fixation assemblies, or one or more portions thereof, are shown in the figures, and will be described herein. In some of the examples, and particularly for drop cable fixation assemblies, the cable fixation assembly includes a base plate and a subassembly that mounts to the baseplate. The baseplate, in turn, mounts directly to the main support structure 111. In particular, the baseplate is configured to be secured to the surface 156 or the surface 158. The base plate can serve as a platform to properly vertically align a drop cable fixation assembly with a cable port defined by the seal blocks.

For the example feeder cable fixation assembly shown in the figures, the cable fixation assembly includes a main body that both secures the cable and is directly mountable to the main support structure 111. In particular, the main body of the feeder cable fixation assembly is configured to be secured to the surface 158.

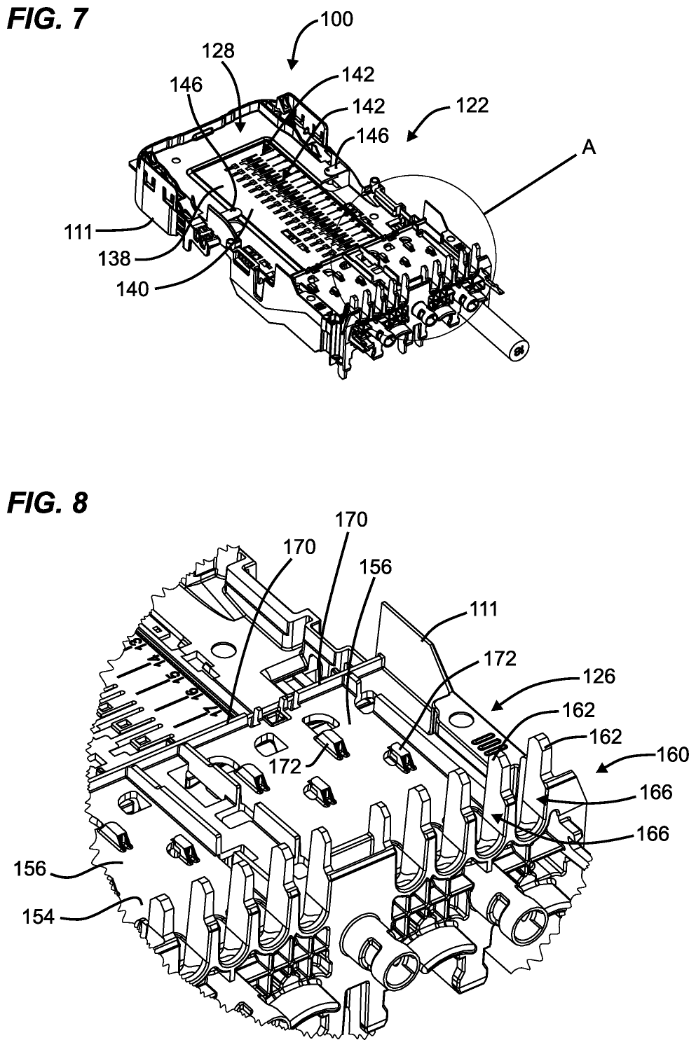

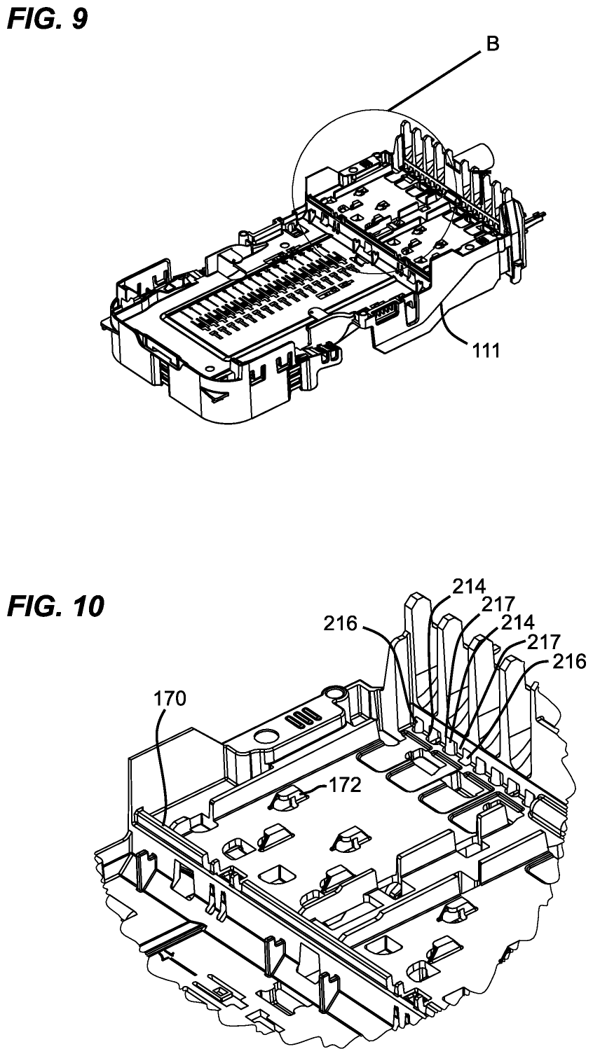

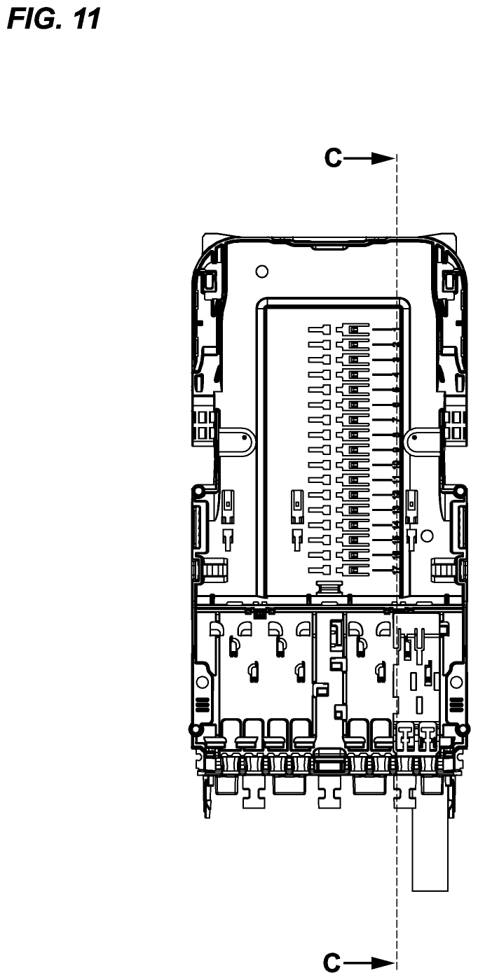

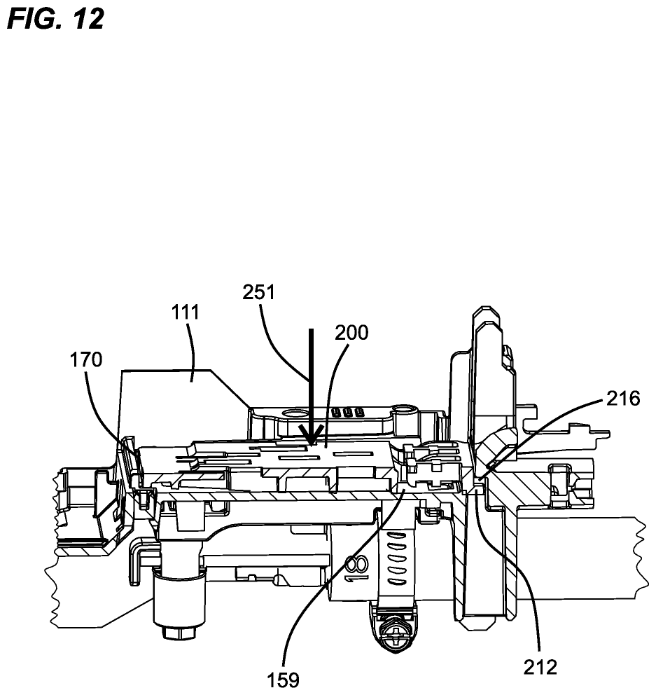

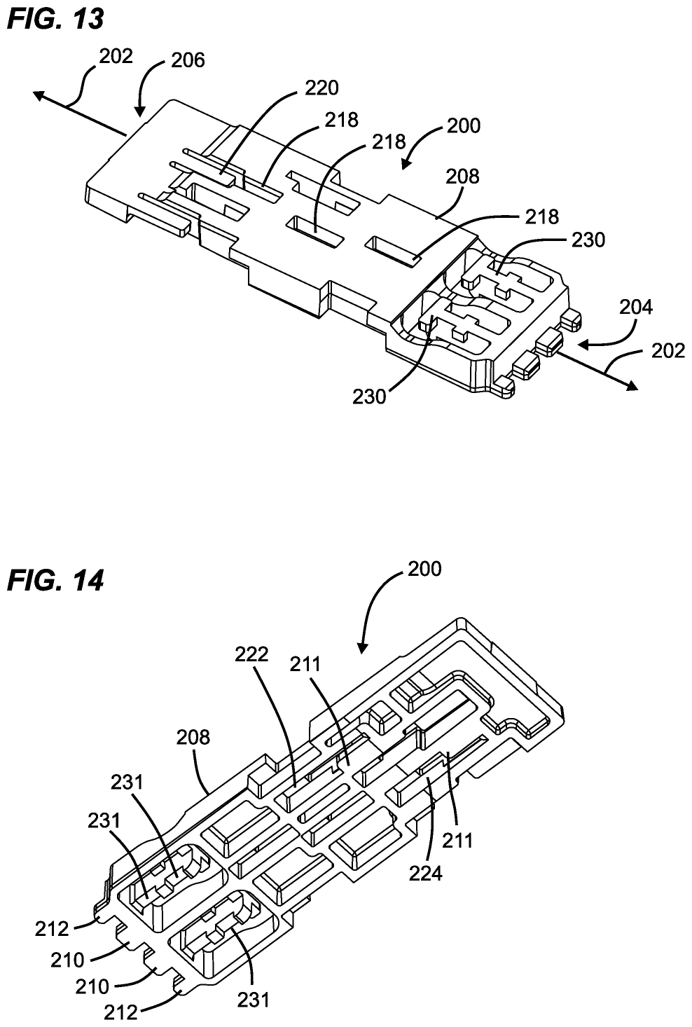

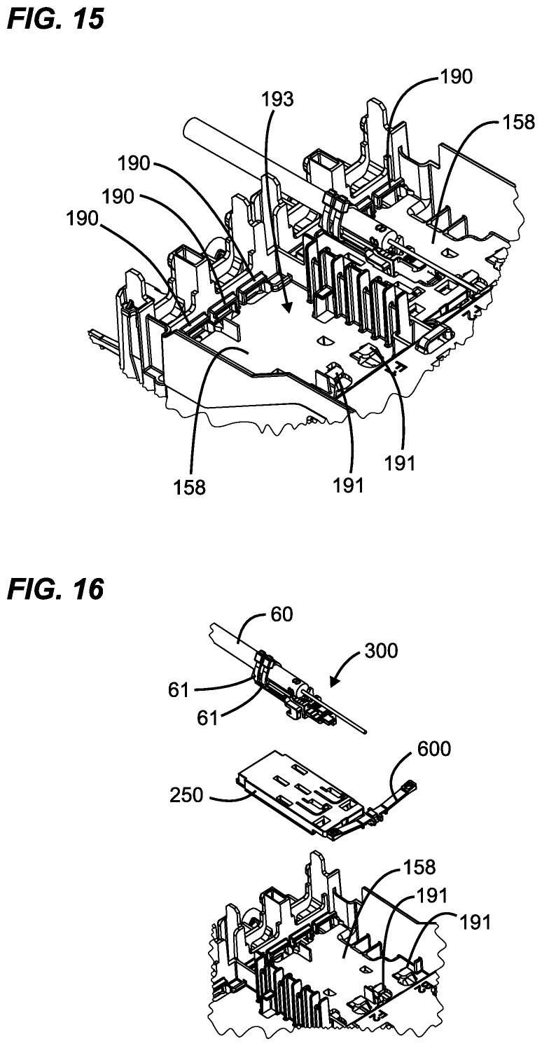

Referring now to FIGS. 7-14, an example baseplate 200 is configured to be mounted to the main support structure 111 at the surface 156. In turn, the baseplate 200 is configured to lockingly mount a drop cable fixation subassembly, such as the subassembly 300 (FIG. 16). The baseplate 200 extends along an axis 202 from a proximal end 204 to a distal end 206, and includes a baseplate body 208. The body 208 is constructed of a sturdy, flexibly resilient material. For example, the body 208 can be a molded polymeric material.

The body 208 defines slots 218. The slots 218 are configured to receive hook members of a cable fixation subassembly, such as the hook members of the subassembly 300 (FIG. 16). The body includes a cantilever 220 at one of the slots 218. The cantilever 220 deflects as the hook members are inserted into the slots 218. The subassembly 300 (FIG. 16) is then moved proximally, causing the cantilever 220 to resiliently return to its unflexed position, thereby locking the subassembly parallel to the axis 202.

The body 208 defines voids or pockets, such as the pockets 222, 224 and catches 211 within the pockets. The pockets 222, 224 are configured to receive baseplate mounting structures 172 of the main support structure 111 (that also can be used to mount a baseplate that is differently configured from the baseplate 200). The baseplate 200 is then slid proximally such that the catches 211 engage within the mounting structures 172 to vertically fix the baseplate 200 to the main support structure 111. Thus, the baseplate 200 is designed to be compatible with a main support structure 111 that is compatible with different configurations of baseplate at the same or different baseplate mounting locations.

The body 208 defines T-shaped tabs 230 having notches 231 configured for securing cable tie wraps (e.g., tie wraps 61). Cable tie wraps (e.g., a zip tie) can be looped around the outer jacket of a drop cable, for example, and around a T-shaped tab 230 within a notch 231 to fix the drop cable 60 to the baseplate 200.

The main support structure 111 includes stop walls 170. Each stop wall 170 projects upwardly from the surface 156.

Projecting proximally from the body 208 are feet 210 and 212. To mount the baseplate 200 to the main support structure 111, the feet 210 and 212 are received in footholds 214 and 216, respectively, defined by the main support structure 111. The footholds are separated by partitions 217, which can inhibit side to side movement of an installed baseplate 200.

To install the baseplate 200, the feet 210, 212 can be slid into the footholds 214, 216. Then, the baseplate 200 can be flexed or bent, by, e.g., applying pressure in the direction of the arrow 251 in an approximately central portion of the baseplate 200, which allows the catches 211 within the pockets 222, 224 to be pushed low enough (e.g., close enough to the main support structure 111) to slide proximally, while the pressure is being applied and the baseplate is bent, into vertical locking engagement with the baseplate mounting structures 172 (e.g., engagement that prevents vertical removal of the baseplate 200 from the main support structure 111). That is, sliding of the baseplate is performed while the baseplate is in a bent state. The baseplate 200 is sized such that, when installed (i.e., mounted at the surface 156), the wall 170 serves as a distal stop, close enough to the distal end 206 of the baseplate 200 to inhibit the baseplate 200 from sliding distally, which in turn prevents distal disengagement of the pockets or hooked structures of the baseplate 200 from the baseplate mounting structures 191, while the interfacing of feet 210, 212 and footholds 214, 216, further secures the baseplate 200 to the main support structure 111. In some examples, the wall 170 frictionally abuts the distal end of the baseplate 200 when the baseplate 200 is fully installed.

Due to the tight clearance between the baseplate 200 and the baseplate receiver (or mounting location) 159 defined by the main support structure 111 (and partially defined by the wall 170) when the baseplate 200 is fully installed in the receiver 159 (which prevents the baseplate 200 from disengaging the main support structure 111 by movement in any direction), to install the baseplate 200 in the receiver 159, the baseplate 200 must be bent, as described, in order for the complementary mounting features of the baseplate 200 and the receiver 159 of the main support structure 111 to lockingly engage each other by proximal movement of the baseplate 200 within the receiver 159.

Thus, the baseplate 200 is configured to be secured to the main support structure 111 with movement that would permit removal of the baseplate 200 from the main support structure 111 inhibited in every direction, without the need or use of a module retainer 600, thereby providing for a simpler configuration of baseplate and/or simpler installation of baseplate to main support structure. The baseplate 200 can be constructed to be sufficiently resiliently flexible to allow the bending needed for installation and resiliently return to its unbent configuration without damage to the baseplate 200.

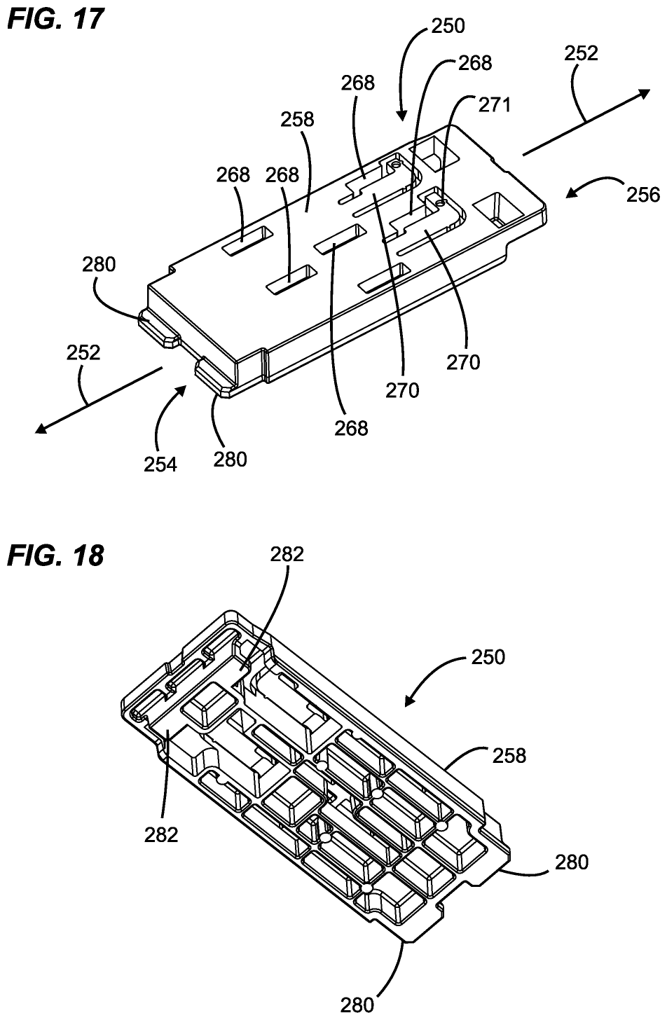

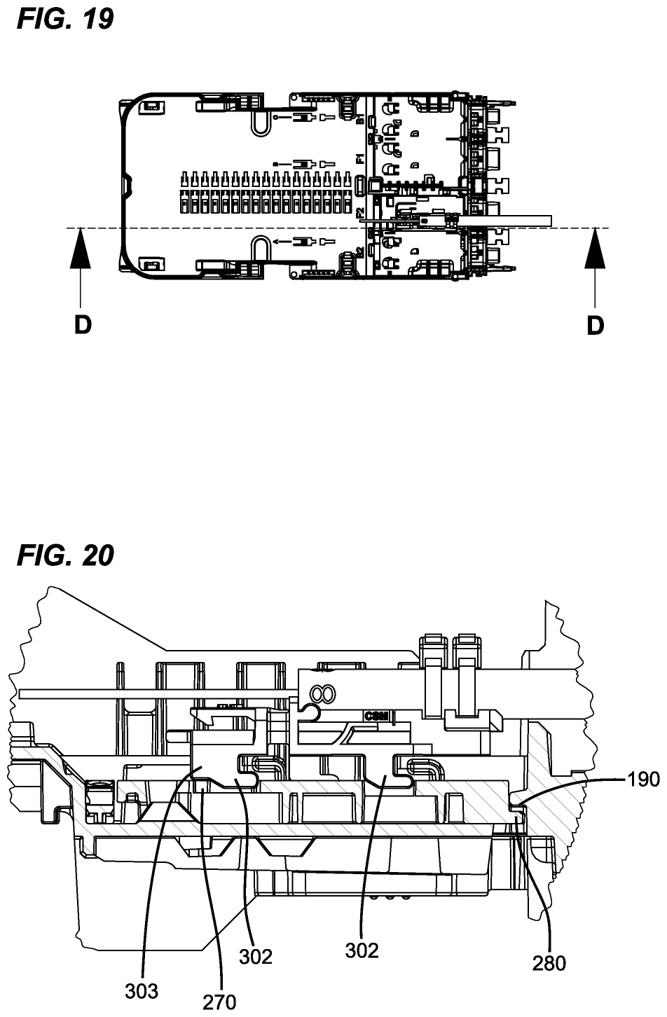

Referring now to FIGS. 15-21, a further example baseplate 250 is configured to be mounted to the main support structure 111 at the surface 158. In turn, the baseplate 250 is configured to lockingly mount one or two drop cable fixation subassemblies, such as one or two of the subassemblies 300 (FIG. 16). The baseplate 250 defines mounting locations for two such subassemblies. The baseplate 250 extends along an axis 252 from a proximal end 254 to a distal end 256, and includes a baseplate body 258. The body 258 is constructed of a sturdy, flexibly resilient material. For example, the body 258 can be a molded polymeric material.

Projecting from the proximal end of the body 258 are laterally spaced apart feet 280. The body 258 also defines laterally spaced apart distal feet 282. By spacing apart the feet 280, 282, proper alignment of the feet with the corresponding engagement structures of the main support structure 111 can be facilitated. When securing the baseplate 250 to the main support structure 111, the feet 280 slide proximally into footholds 190 defined by the main support structure 111, and the feet 282 slide proximally into the baseplate mounting structures 191 also defined by the main support structure 111.

A module retainer 600 can be used to further secure a module to the main support structure 111 at the surface 158. A module can include a baseplate, such as the baseplate 250. A module can alternatively include the main body of a feeder cable fixation assembly, as described further below. Each module retainer 600 is configured to engage and help secure up to two modules. The modules retained by the module retainer 600 can be of the same type or a different type (e.g., one of the modules can be a baseplate and the other can be the main body of a feeder cable fixation assembly). Additional details about the features and function of the module retainer 600 will be described below.

A drop cable fixation subassembly can be mounted to the baseplate 250 before or after the baseplate 250 is mounted to the main support structure 111.

The body 258 defines slots 268. The slots 268 are configured to receive hook members of a cable fixation subassembly, such as the hook members 302 of the main body 303 of the subassembly 300, the main body 303 directly supporting the cable 60.

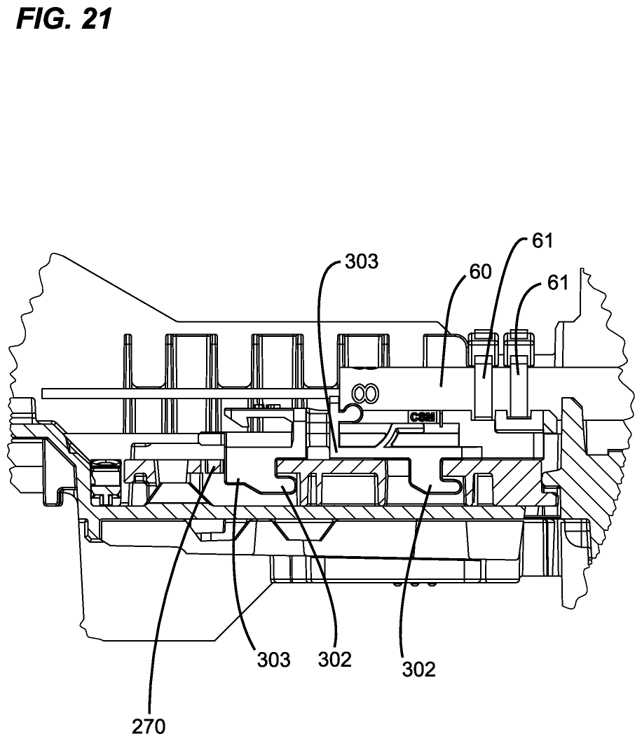

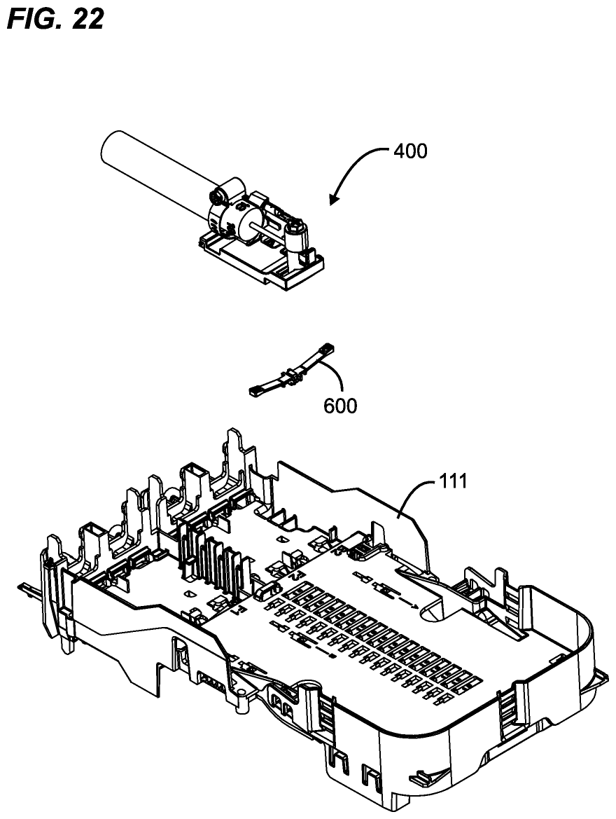

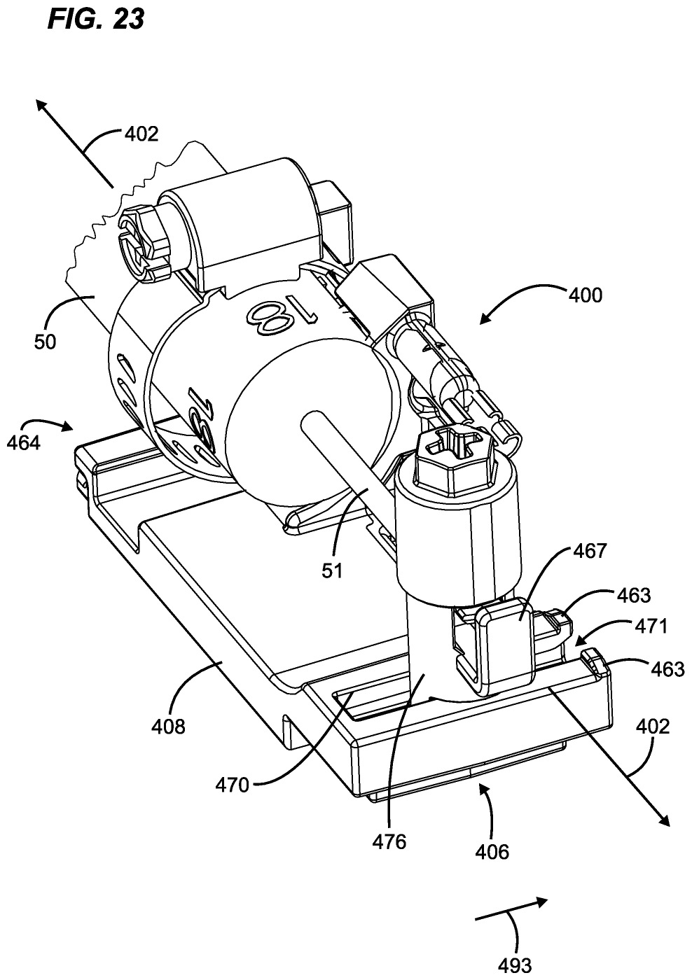

The body 258 includes an L-shaped cantilever 270 at one of the slots 288 at each subassembly mounting location. The cantilever 270 deflects upward as the hook members 302 are inserted into the slots 268, with the heel 303 of one of the hook members 302 engaging and flexing the cantilever 270, as shown in FIGS. 20-21. The subassembly 300 (FIG. 16) is then moved proximally (FIG. 21), causing the cantilever 270 to resiliently return to its unflexed position, thereby locking the subassembly parallel to the axis 252 by blocking distal movement of the subassembly 300 through physical engagement parallel to the axis 202 of the heel 303 and the cantilever 270. The hook members 302 are thereby secured to the baseplate 250.

Each cantilever 270 includes a hole, or a depression 271. To remove a cable fixation subassembly from the baseplate 200, a tool, such as a fiber pick, can be inserted in the corresponding depression 271, to deflect the cantilever upwards, allowing the subassembly 300 to be shifted distally until the hook members can be withdrawn downward through the slots 268.

The cantilever 270 is thus of unitary construction with the rest of the baseplate 250, rather than a separate piece that is coupled to the baseplate, thereby providing for a simple construction of a minimal number of parts for securing a drop cable subassembly to the baseplate.

In addition, as shown and described the baseplate 250 is configured to mount to the same cable fixation interface 193 to which can alternatively be directly mounted feeder cable fixation assemblies. Thus, the baseplate 250 is configured as an adapter component for adapting the feeder cable fixation interface 193 of the main support structure 111 for use in affixing drop cables, thereby increasing the versatility of the organizer and the closure containing the organizer, in that either or both sides of the main support structure 111 can be used for affixing drop cables entering the closure.

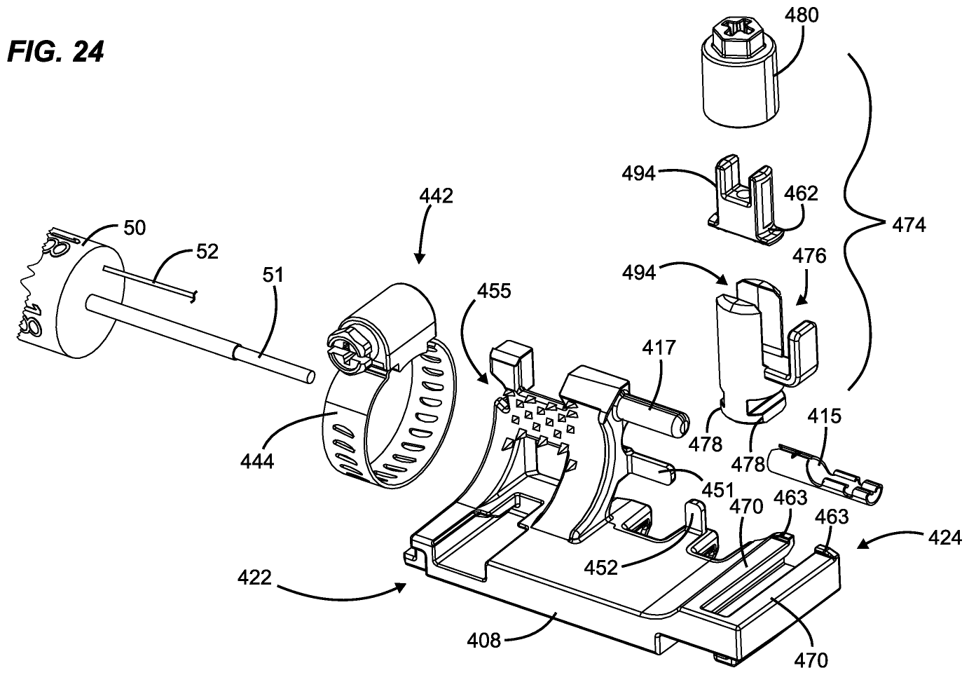

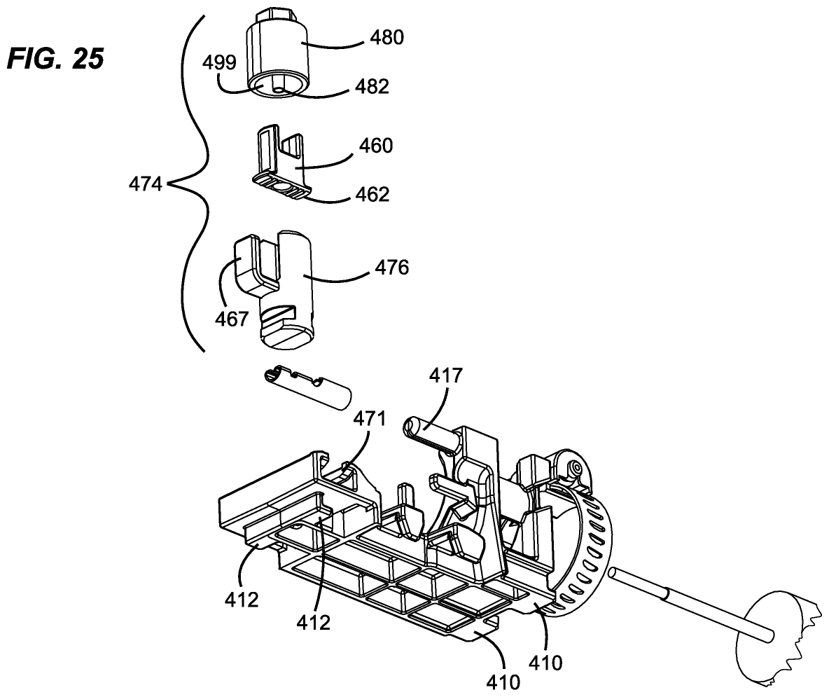

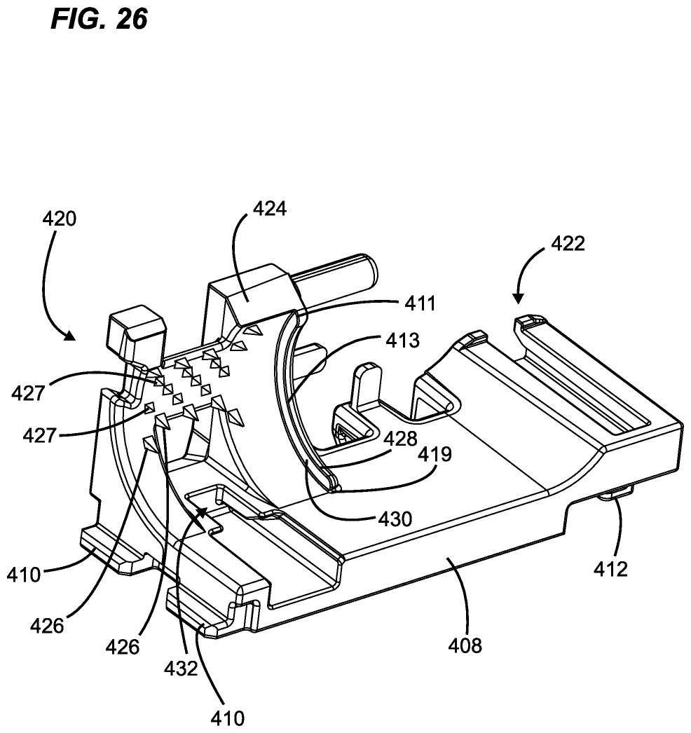

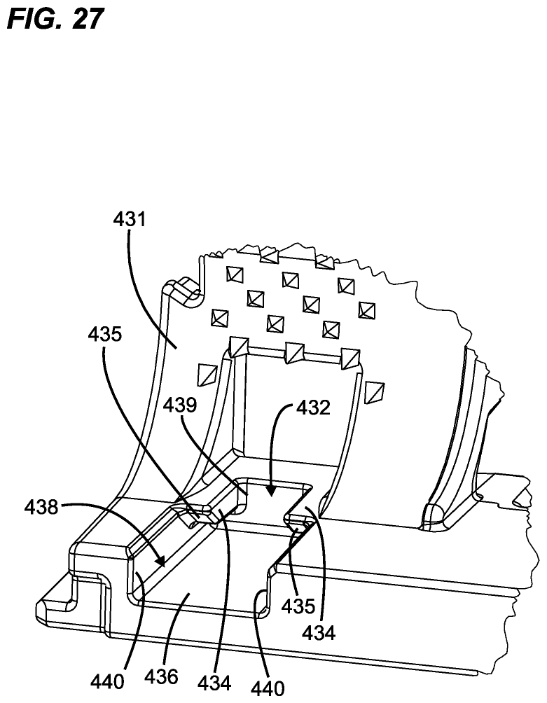

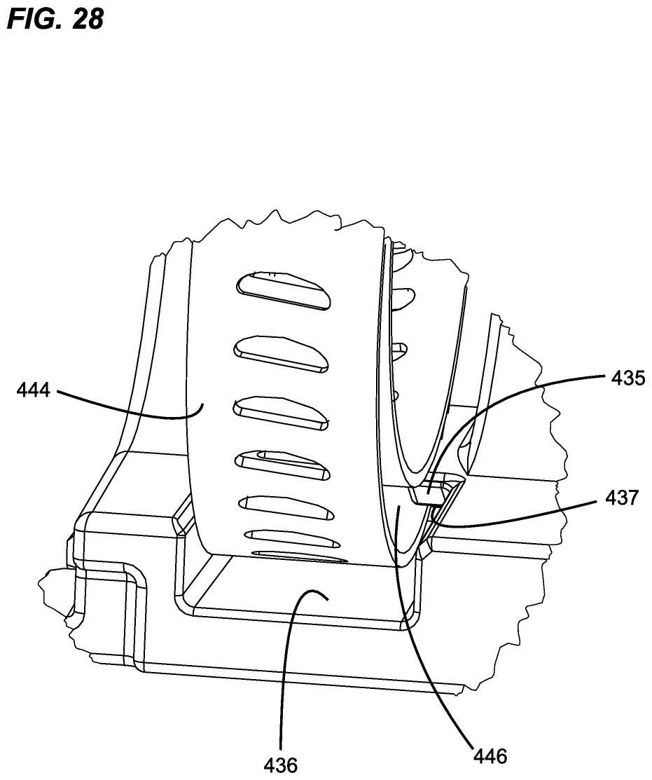

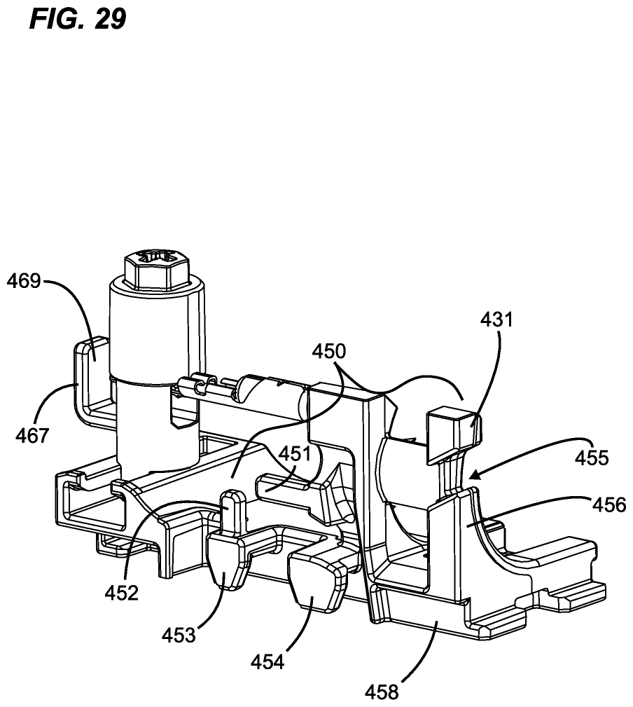

Referring now to FIGS. 22-29, features of a feeder cable fixation assembly 400 will be described. The assembly 400 is configured to fix a feeder cable 50. In addition, the assembly 400 is configured to mount directly to the surface 158 of the main support structure 111, e.g., without a baseplate. The assembly 400 extends along an axis 402 from a proximal end 404 to a distal end 406.

The assembly 400 includes a main body 408. The main body 408 can be of unitary construction, including all of the features of the main body 408.

The main body 408 includes feet 410 and feet 412. The feet 410 are laterally spaced apart feet, as are the feet 412. By spacing apart the feet 410, 412, proper alignment of the feet with the corresponding engagement structures of the main support structure 111 can be facilitated. When securing the main body 408 to the main support structure 111, the feet 410 slide proximally into the footholds 190 defined by the main support structure 111 in a similar fashion as the corresponding feet of the baseplate 250 described above.

Similarly, the feet 412 slide proximally into the baseplate mounting structures 191 also defined by the main support structure 111 in a similar fashion as the corresponding feet of the baseplate 250 described above.

The module retainer 600 can be used to further secure the main body 408 to the main support structure 111 at the surface 158. Additional details about the features and function of the module retainer 600 will be described below.

The main body 408 includes a cable jacket fixation portion 420 and a strength rod fixation portion 422. In addition, an electrically conductive connector 415 is frictionally fit or crimped to a grounding post 417. An electrical grounding conductor for the closure can be secured to the connector 415.

The cable jacket fixation portion 420 includes jacket support 424 having teeth 426, 427 of different sizes projecting from the jacket support 424. The teeth are configured to dig into the outer jacket of, e.g., a feeder cable 50, or another type of cable, such as a branch cable.

The jacket support 424 includes a shoulder 428. The shoulder 428 defines a proximally facing surface 430. The shoulder 428 and the surface 430 have a curvature that corresponds to, or approximately corresponds to, the curvature of the cable jacket of the feeder cable 50 secured to the main body 408. In the example shown, the shoulder 428 and the surface 430 are curved continuously at an outer edge 413 from one end 411 of the shoulder 428 to the opposite end 419 of the shoulder 428. The surface 430 can act as a distal stop that engages a distal end of the outer jacket of the cable 50 and inhibits further distal movement of the cable 50 relative to the main body 408 when a longitudinal axis of the cable is parallel to the axis 402. Inhibiting such distal movement can be particularly advantageous when initially fixing the cable 50 to the main body 408. In that scenario, the shoulder 428 and surface 430 can help to maintain proper positioning of the cable when fixing the cable to the main body 408. The shoulder 428 can be sized and shaped (e.g., curved as described above) to engage the cable jacket but not to interfere with internal cable components that might extend beyond the distal end of the cable jacket, such as strength yarn, a strength rod, a buffer tube, a conductive shield, an optical fiber, and so forth.

The cable jacket fixation portion 420 defines a pocket 432. The pocket 432 is defined by a portion of a top surface 436 of a recess 438, portions of side surfaces 440 of the recess 438, and opposing shoulders 434. Each shoulder 434 includes a ramped surface 435 leading into the pocket 432 from the portion of the recess 438 that is outside the pocket 432. The shoulders 434 are spaced apart from each other along the axis 402 with a gap 439 therebetween. A maximum width of the gap 439 parallel to the axis 402 can be less than a corresponding transverse width of the strap 444, to thereby retain the strap overlength portion, which may have a tendency to curl out of the pocket, within the pocket. The gap 439 can permit axis to the overlength of the strap 444 received in the pocket 432. For example, a tool, such as a fiber pick, can be inserted through the gap 439 to adjust the position of the overlength in the pocket 432 or to assist in removing the overlength from the pocket 432.

The ramped surfaces 435 can serve as guides for gently guiding the strap overlength from the recess 438 into the pocket 432.

The pocket 432 is configured to receive and retain overlength of the strap of the cable clamp. For example, the assembly 400 includes a hose clamp 442 for clamping the cable 50 to the main body 408. Depending on the thickness of the cable and the length of the strap of the cable clamp, there may be excess strap length. The excess strap length can be difficult to remove. For example, in the case of a hose clamp 442, the strap 444 is constructed of a relatively thick metal that can be hard to cut and, even when cut, can leave sharp edges that can damage optical fibers or other components of a telecommunications closure. On the other hand, an unretained overlength of a strap can likewise pose a risk to delicate optical fibers in the vicinity of the assembly 400. The pocket 432 is configured to receive an overlength 446 of a strap 444 of a cable clamp and retain the overlength in the pocket 432 to prevent or minimize undesirable interference between the overlength and other telecommunications equipment.

Retaining cable clamp overlength in the pocket 432 can be particularly advantageous when the strap 444 of the cable clamp is significantly longer than the transverse circumference of the cable jacket of the cable being secured by the cable clamp.

The assembly 400 includes a strength member fixation subassembly 474 for anchoring a rigid strength rod, such as the rigid strength rod 51. The subassembly 474 can be selectively included or not included in the overall assembly. Depending on the cable and strength member characteristics, the subassembly 474 may not be needed or appropriate and can be advantageously dispensed with entirely in some use applications, due to the manner in which it mounts to the main body 408.

The subassembly 474 includes a lower strength member clamp body 476 defining opposing shoulders 478 configured to couple to and slide horizontally and perpendicularly to the axis 402 along the tracks 470 defined by the main body 408 to adjust a transverse position of the strength member fixation subassembly 474. The subassembly 474 also includes an upper strength member clamp body 480 that includes a press pin 482. Interior threads of the upper strength member clamp body 480 cooperate with exterior threads of the lower strength member clamp body 476 to allow rotational advancement of the upper clamp body towards the lower clamp body.

The transverse position (perpendicular of the lower clamp body 476) can be set relative to the tracks 470 by clamping of a cable strength rod 51 in the subassembly 474.

The lower clamp body 476 includes a channel 494. The strength rod 51 of the cable 50 is received in the channel 494.

The subassembly 474 also includes a press block 460 having a unitarily integrated press plate 462. The press block 460 is positioned in the channel 494 such that the press plate 462 is positioned directly above the strength rod 51.

The upper strength member clamp body 480 is threadably screwed onto the lower clamp body 476, causing the press pin 482 and other portions of the upper clamp body 480 to press on the upper side of the press plate 462 and thereby anchor the strength rod 51 within the channel 494. The block 460 is a robust part that can resist deformation by the clamping action of the clamping bodies above and below it. The block 460 is shaped and configured to be positioned within a cavity 499 defined by the upper strength member clamp body 480.

The transverse slidable cooperation between the lower clamp body 476 and the tracks 470 can advantageously allow for longitudinal alignment of the strength member fixation subassembly 474 for strength rods of different cables.

In addition, the main body 408 includes opposing lips 463 projecting downward from each of the tracks 470 at the open end 471 of the tracks 470 where the lower clamp body 476 is slid into engagement with the tracks 470. The lips 463 act as stops for inhibiting disengagement of the lower clamp body 476 from the tracks 470. This feature can be particularly advantageous when assembling the subassembly 474 and securing a strength rod therein, as there can be a tendency during installation for the lower clamp body 476 to slide out of engagement with the tracks 470, and thereby out of engagement with the main body 408. In such a scenario, as the lower clamp body 476 slides in the direction of the arrow 493 toward the open end 471, the lower clamp body 476 engages the lips 463, stopping the lower clamp body 476 from passing through the open end 471 and disengaging from the tracks 470.

The lower clamp body 476 also includes an L-shaped strength rod stopper 467 extending distally from the lower clamp body 476 and having a proximally facing surface 469. The surface 469 can serve as a distal stop to prevent further distal growth or creepage of the strength rod 51 beyond the stopper 467. Strength rod growth or creepage can damage optical components. The surface 469 of the L-shaped member 467 can advantageously minimize or prevent such growth or creepage further into the closure.

Referring to FIGS. 22-31, the main body 408 includes a yarn post arrangement 450 that includes a plurality of posts and a notch. The arrangement 450 includes posts 451, 452, 453, and 454 and a notch 455. The notch 455 is located towards a lower end of an arm 456 of the jacket support 424 of the cable jacket fixation portion 420 of the main body 408. The notch 455 has an open end at a proximal end of the main body 408 and extends proximally to a closed end of the notch 455. Each post projects from a fixed end of the post to a free end of the post.

The configuration of the arrangement 450 can support a plurality of different winding configurations for strength yarn 52 of the cable 50. Strength yarn 52 can be included in the cable 50 to provide further robustness to the cable 50 and further protection of the fibers of the cable 50 against exterior loads applied to the cable. Winding the strength yarn 52 around the posts of the arrangement 450 can, advantageously, secure the yarn without pulling on it tightly. That is, due to the winding configuration, the yarn is fixed without having to pull it detrimentally tightly. In addition, due to the winding configuration, the yarn is well anchored and unlikely to loosen itself.

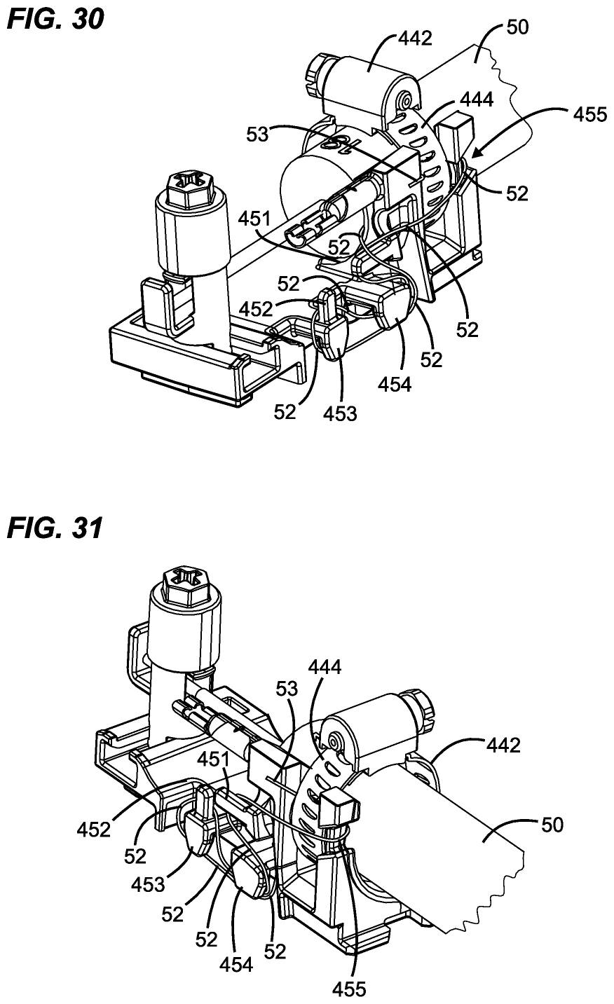

An example winding configuration of the yarn 52 using the arrangement 450 is shown in FIGS. 30 and 31. The yarn 52 extends from the jacketed portion of the cable 50, and is then routed in front of the post 451, then behind the post 454, then behind the post 452, then behind the post 453, then behind the post 454, then behind the post 451, then around the arm 456 through the notch 455. The remainder can then be clamped to the cable jacket with the strap 444, leaving a free end portion 53 of the yarn 52. Alternative routing configurations for the yarn 52 are possible using the arrangement 450.

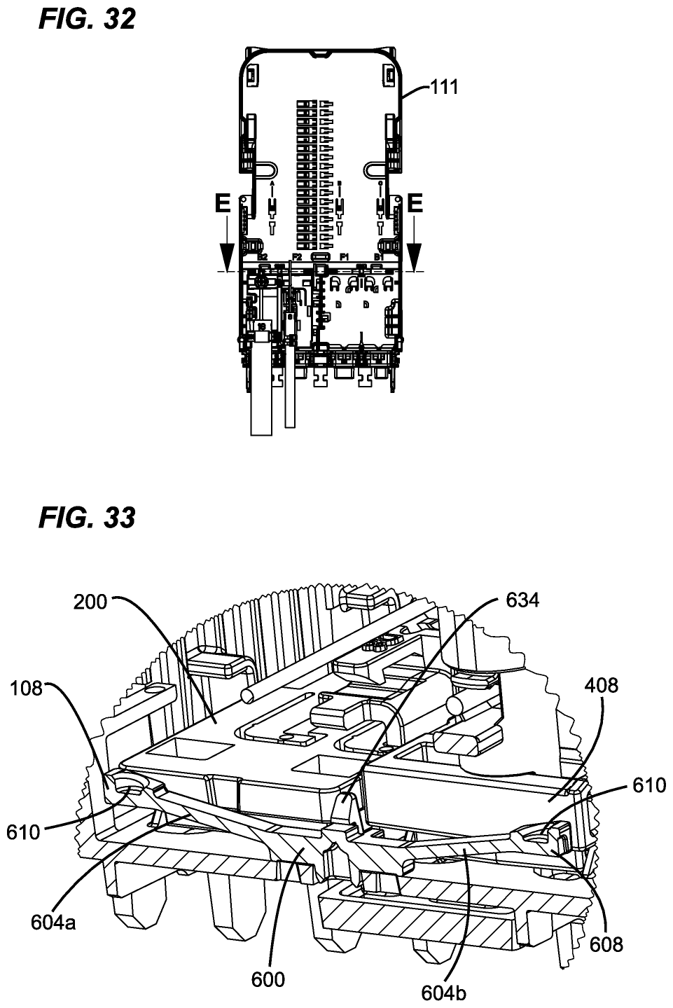

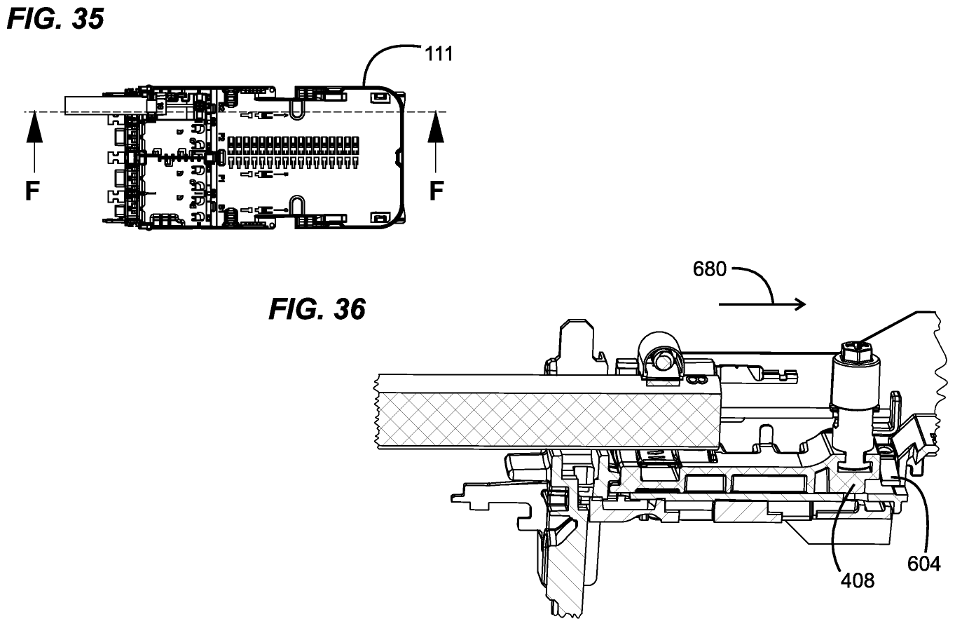

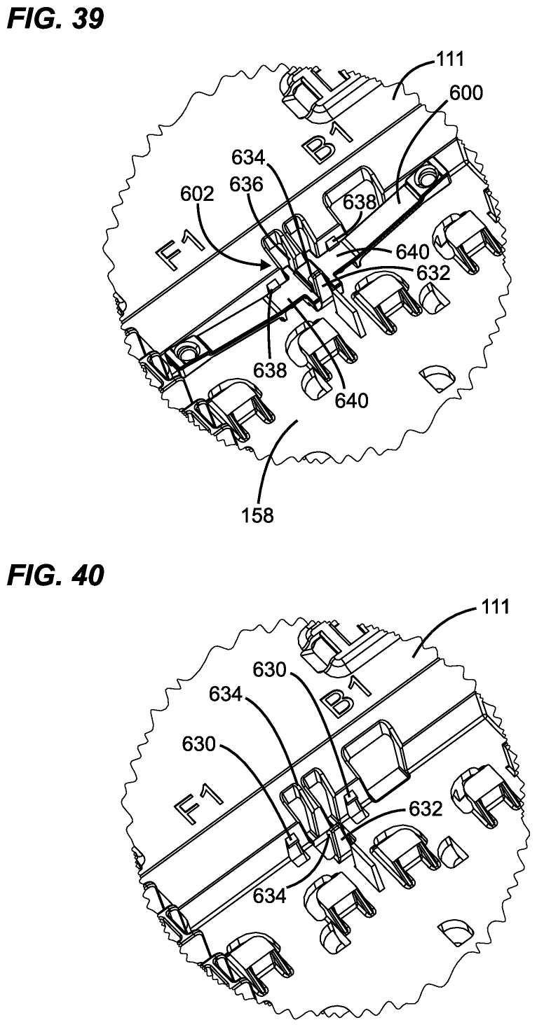

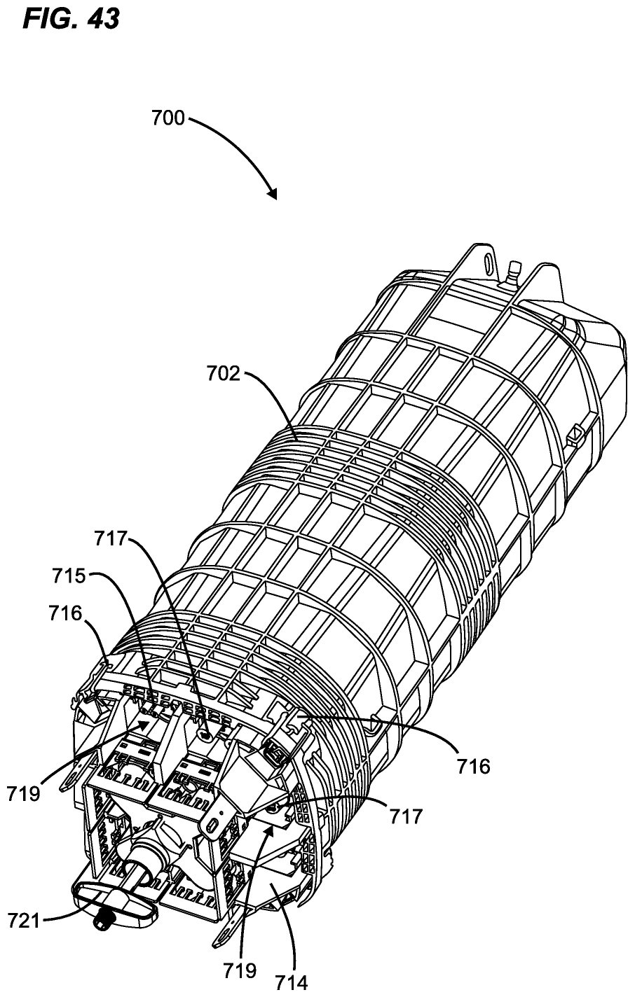

Referring now to FIGS. 32-42, features and functionality of the module retainer 600 will be described.

As shown, each module retainer 600 is configured to horizontally retain up to two modules, such as the baseplate 200 and the main body 408.

The module retainer 600 can be a unitarily integrated molded part (e.g., molded of a polymeric material) that can be selectively installed and removed from the main support structure 111, depending on the fiber management needs of the closure.

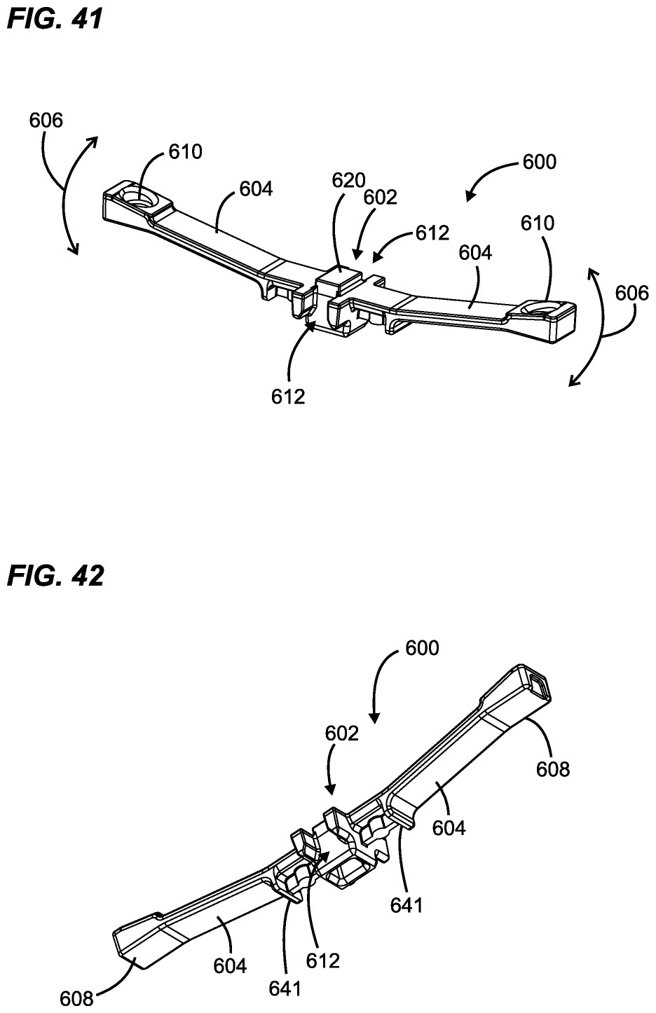

The module retainer 600 includes a central body 602 and flexibly resilient arms 604 extending in opposite directions from the central body 602. The central body 602 includes opposite reinforcement ribs 641. The arms 604 extend from the ribs 641. Each arm 604 is configured to resiliently flex about the arm's fixed end with the central body 602 at the corresponding rib 641. Thus, referring to FIG. 41, each arm 604 can resiliently flex in the directions of the corresponding arrows 606. In some examples, the arms are symmetrical about a vertical axis that bisects the central body 602.

Towards the free end of each arm 604 is a tool receiving portion 608. Each tool receiving portion 608 can be thicker than a corresponding thickness of the arm 604. Each tool receiving portion 608 defines a recess 610. The recess 610 is configured to receive a tool (e.g., the tip of a fiber pick), which can be used to flex the arm 604 about its fixed end in order to, e.g., install or a remove a module.

The central body 602 is configured to snappingly engage the main support structure 111 in order to mount the retainer 600 to the main support structure 111. Specifically, the central body 602 defines opposite sockets 612. The sockets 612 are configured to receive structures 632 and 636 defined by the main support structure 111.

The central body 602 is pushed upward toward the surface 158, with the structures 632 and 636 being received in the sockets 612, and thereby properly aligning the retainer 600 until the catch 634 projecting from the structure 632 snappingly engages the surface 620 of the central body 602 and the catches 638 snappingly engage the surfaces 640 of the central body between the ribs 641. The central body 602 is thereby securely seated in the main support structure 111, while the arms 604 remain resiliently flexible about their fixed ends.

Referring to FIG. 34, an arm 604a of the retainer 600 is in an unflexed position and thereby retaining the baseplate 200, acting to inhibit movement of the baseplate 200 in the direction of the arrow 687. The arm 604b of the same retainer 600 is shown in a flexed position, allowing the main body 408 to be slid in the indicated by the arrow 687, in order to remove the main body 408 from the main support structure 111.

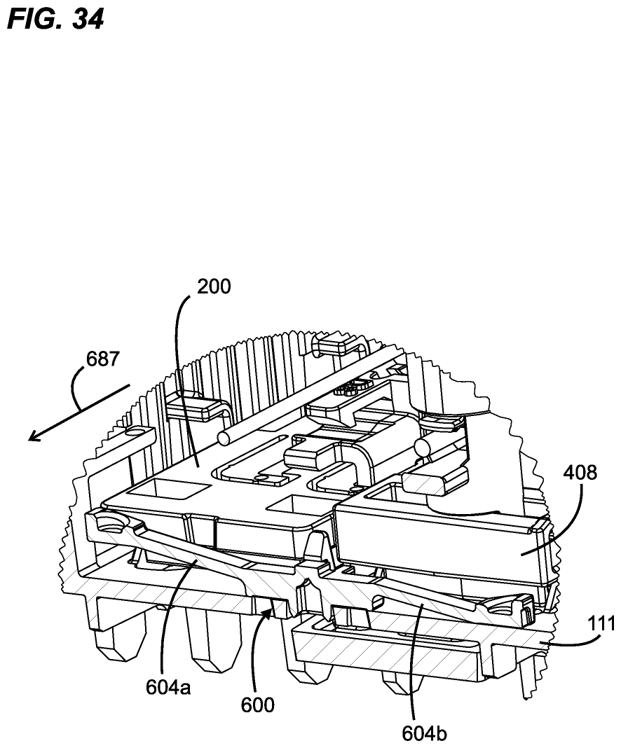

Referring to FIG. 33, both arms 604a and 604b are in the unflexed position, retaining, respectively, the baseplate 200 and the main body 408 with respect to the main support structure.

Referring to FIG. 36, the arm 604 is in an unflexed position, retaining the main body 408 by acting to inhibit movement of the main body 48 in the direction of the arrow 680.

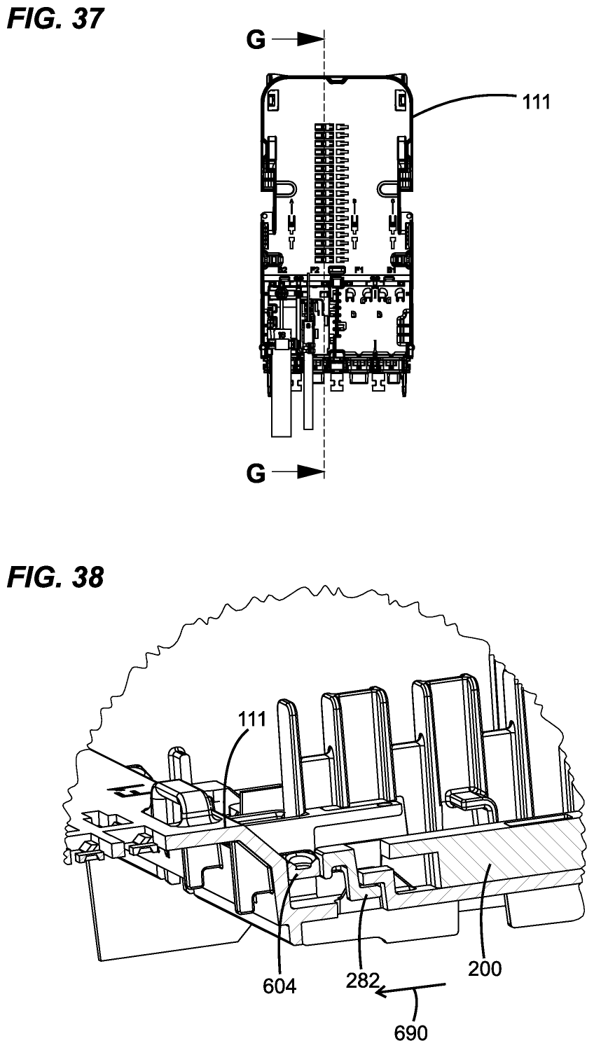

Referring to FIG. 38, the arm 604 is in an unflexed position, retaining the baseplate 200 by acting to inhibit movement of the baseplate 200 in the direction of the arrow 690.

FIG. 43 is a perspective view of further example telecommunications equipment 700 to which cables can be affixed according to the present disclosure. Referring to FIG. 43, the equipment 700 includes a sealable and re-enterable closure. In other examples, the equipment can include other components at a distribution location of an optical fiber network. Such equipment can include, for example, a cabinet, a drawer, a shelf, or a panel for organizing and routing optical fibers.

The closure 700 includes a first housing piece 712 (in this case, a dome), and a second housing piece 714 configured to cooperate with the first housing piece to define a sealable and re-enterable telecommunications closure for managing optical fibers. The first and second housing pieces 712, 714 define an interior closure volume in which other fiber managing equipment can be housed.

Clamps 716 can be used to compress a seal element between the housing pieces 712 and 714 and thereby clamp and seal together the housing pieces 712 and 714. An actuator 721 can be rotated to compress sealing elements around the cables entering the closure and/or to compress a seal element between the housing pieces.

Cables (such as cables 715 and 717) carrying optical fibers can enter the closure volume via sealable ports 719 defined by the second housing piece 714. Such cables can include trunk cables, feeder cables, branch cables, and distribution cables (also known as drop cables). Likewise, electrical grounding conductors or cables can sealingly enter the closure in the same manner.

Typically, optical fibers from one cable entering the closure are spliced to optical fibers of one or more other cables entering the closure to establish an optical signal path at the closure 700 (or other signal distribution equipment) from a provider side cable to one or more customer side cables. In this manner, optical signals can be transmitted from one cable to another cable via the closure 700, e.g., from a feeder cable to a drop cable, from a feeder cable to another feeder cable (that feeds another closure), from a feeder cable to a branch cable (which branches out to multiple other terminals), etc.

In addition to splicing, other fiber management activities can be performed with telecommunications equipment housed within the closure volume. Such activities can include, without limitation, indexing fibers, storing fibers (typically in one or more loops) splitting signals of fibers, and establishing optical connections with connectorized fibers and adapters, etc.

Splices, such as mechanical splices or fusion splices, can be performed at the factory or in the field, e.g., at the closure 700 positioned in the field.

The cables entering the closure can include fibers of different configurations such as loose fibers and fiber ribbons. The fiber ribbons can be flat ribbons or rollable ribbons. The loose fibers can be individual fibers or bundled loose fibers protected by a common protective sheath or tube. For fiber ribbons, the fibers of the entire ribbon can be spliced to the fibers of a corresponding fiber ribbon at the same time, e.g., using a mass fusion splicing procedure.

Splice bodies protect the splices both in the case of individual fiber splices and mass fiber splices, such as mass fusion splices. The splice bodies are held in splice holders also known as splice chips. Fiber management trays can support such splice holders (or chips). The fiber management trays can be stacked in stacks to support modules mounted to a frame all housed within the closure volume. The trays are pivotal relative to the support modules such that a desired tray in the stack can be accessed by pivoting one or more of the trays away from the desired tray.

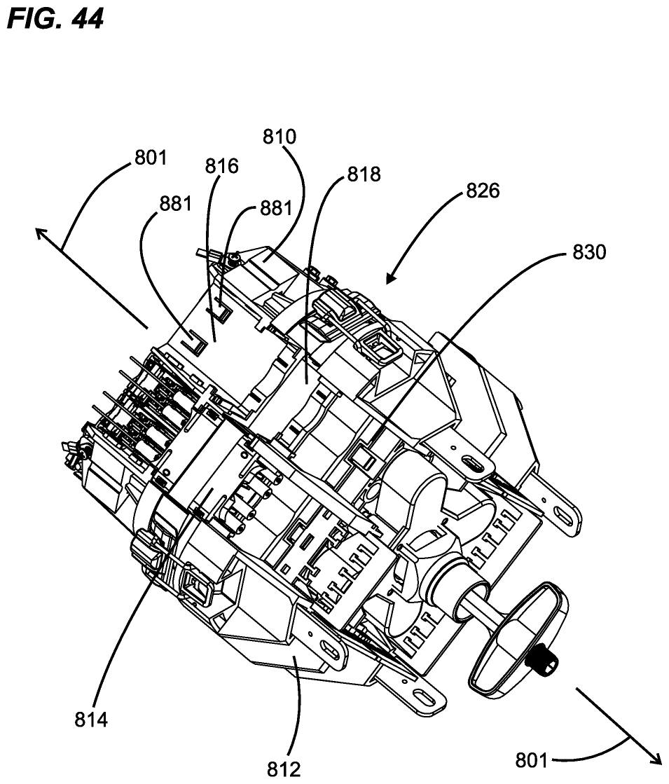

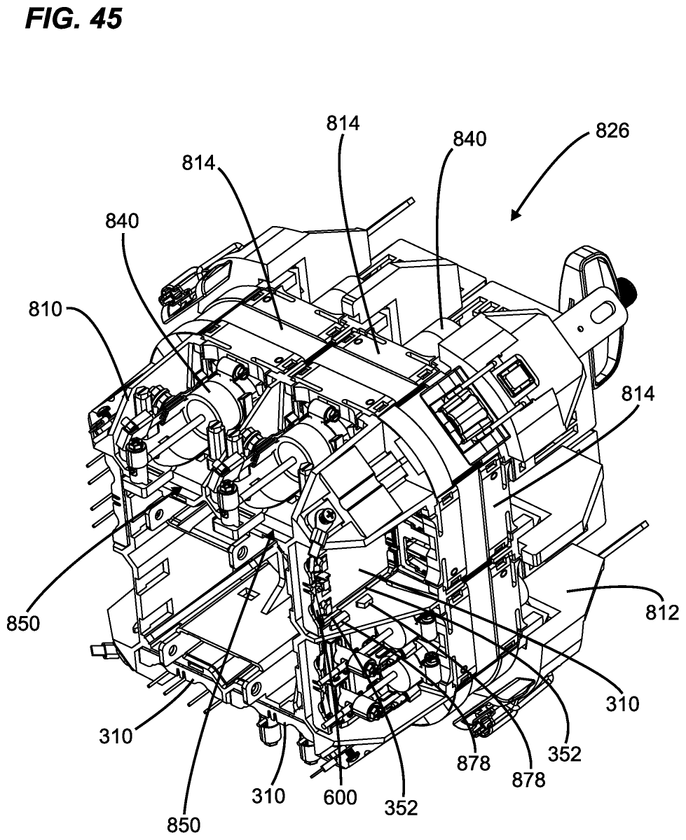

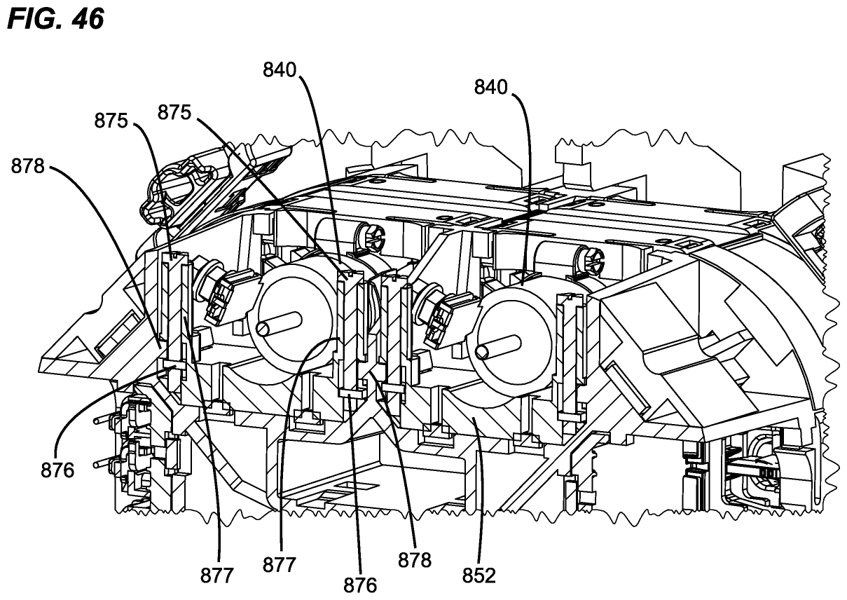

FIG. 44 is a perspective view of the base assembly 826 of the equipment of FIG. 43. FIG. 45 is a further perspective view of the base assembly 826 of FIG. 44.

Referring to FIGS. 44-45, the base assembly 826 includes a first base piece 810 and a second base piece 812. The second base piece 812 corresponds to the housing piece 714 (FIG. 43).

Cables of different sizes and shapes can enter the closure through the base assembly 826. Such cables pass through seal modules 814. Each seal module includes one or more sealing members (e.g., gel blocks) that are housed in seal block retainers. The actuator can compress the seal members around the cable. The modules 814 are arranged circumferentially around the axis 801, which is parallel to the elongate dimension of the closure.

Each module 814 can be dedicated to a particular type of cable. For example, some modules 814 can seal around drop cables, others around flat cables, others around round feeder cables, etc. The drawings show a variety of cable types passing through modules 814.

Arranged around the axis 801, the first base piece 810 defines receivers 816 for mounting interior cable fixation assemblies, including assemblies 850. Each cable fixation assembly 850 is configured to affix a large diameter cable 840. That is, in some examples, the cable 840 has an outer jacket having a diameter (perpendicular to a longitudinal axis of the cable) of at least 20 millimeters, or at least 25 millimeters or at least 30 millimeters, though diameters outside of these ranges are also possible. In some examples, the outer diameter of the cable 840 is approximately 30 millimeters, or between about 28 millimeters and about 32 millimeters. The large size of the cable 840 can reflect a large number of optical fibers carried by the cable 840. Due to the large diameter of the cable 840, firmly affixing the cable can be challenging, as the cable tends to be unwieldy and has a large surface area in contact with the sealing elements of the modules 814. In addition, the sheer diameter of the cable 840 can be too large for some typical cable fixation components to have the needed fixation effect. In addition, such large cables often include a metallic electrical shield within the outer jacket and surrounding the optical fibers, which shield within the closure volume must be connected to an electrical ground.

Each receiver 816 is associated with a receiver 818, also defined by the first base piece 810, for mounting a seal module 814.

Arranged around the axis 801, the second base piece 812 defines receivers 830. Each receiver 830 is associated with (e.g., aligned parallel to the axis 801 with) a corresponding receiver 818 and a corresponding receiver 816 defined by the first base piece 10. Each receiver 818 is configured for mounting an exterior cable fixation subassembly or component.

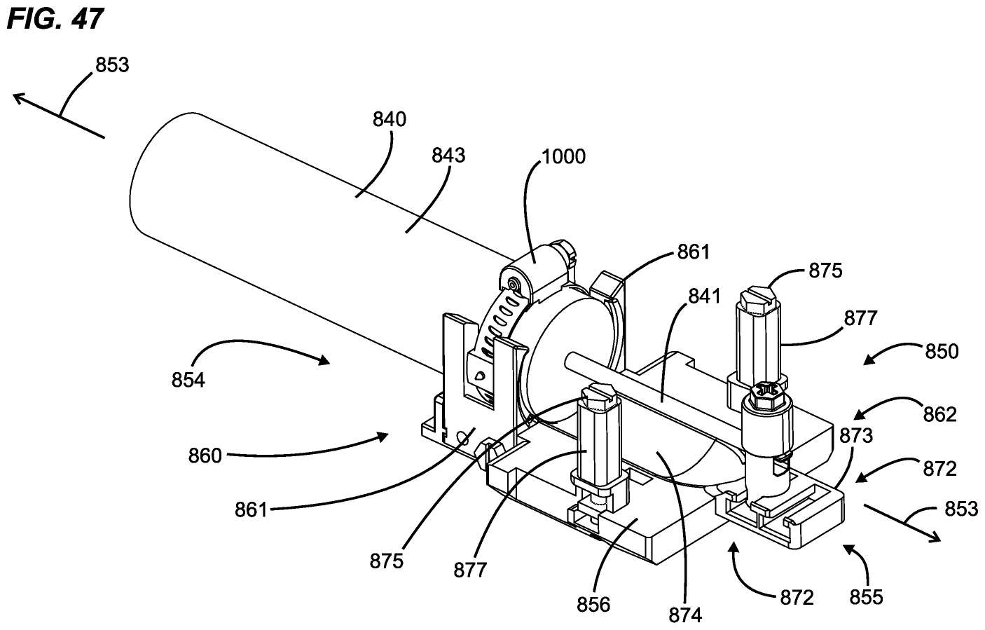

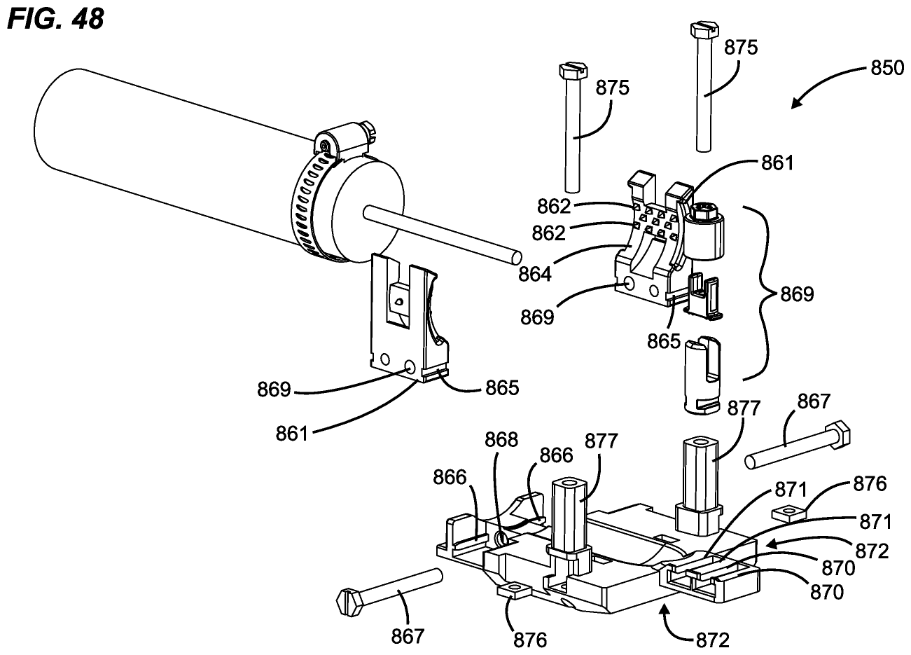

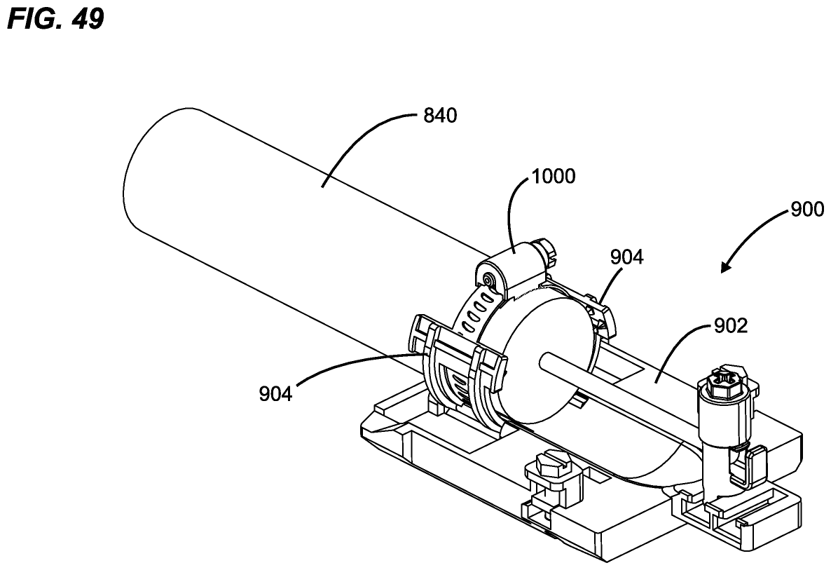

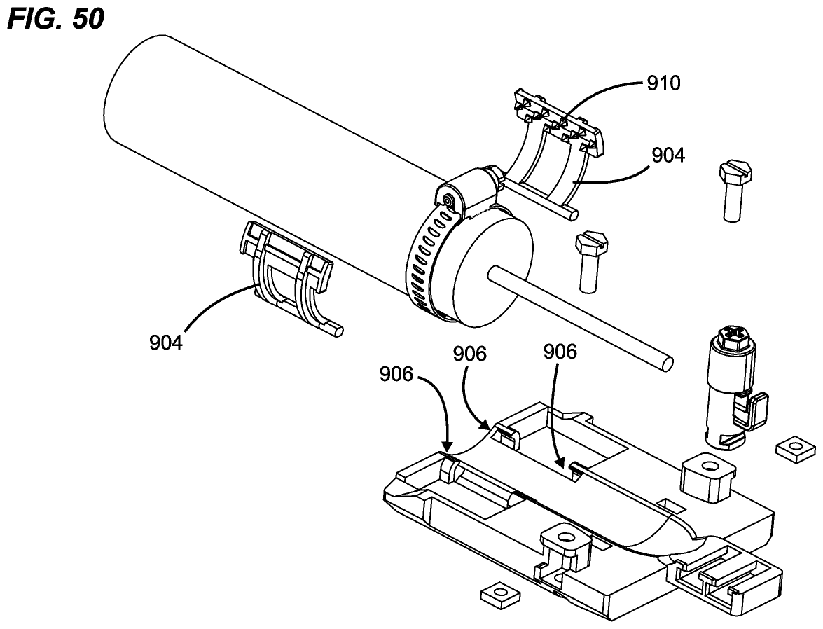

Referring to FIGS. 46-48 and 58, features of the assembly 850 will now be described. The assembly 850 is configured to fix a large diameter cable 840. In addition, the assembly 850 is configured to mount directly to a receiver 816 without an additional baseplate. The assembly 850 extends along an axis 853 from a proximal end 854 to a distal end 855.

The assembly 850 includes a main body 858. The main body 858 can be of unitary construction, including all of the features of the main body 858.

In at least some examples, the main body 858 is made of metal, to provide additional strength and integrity to the main body to fixedly support the large cable 840, as well as to facilitate electrical grounding of the cable shield of the cable 840 via the main body 858. Other components of the assembly 850 can likewise be made of metal. Alternatively, one or more components of the assembly 850 can be constructed of a polymeric material.

The main body 858 includes a cable jacket fixation portion 860 and a strength rod fixation portion 862 for fixing a rigid strength rod 841 of the cable 840. The cable jacket fixation portion 860 includes two jacket supports 861 having teeth 899. The teeth 899 are configured to dig into the outer jacket 843 of the cable 840. Each jacket support 861 includes a surface 864 defining a curvature that corresponds to, or approximately corresponds to, the curvature of the cable jacket 843.

Each jacket support 861 include opposing grooves 865 configured to slidingly receive complementary ribs of the main body 858. Thus, the jacket supports can be slidingly adjustably mounted to the main body 858 along an axis perpendicular to the axis 853 to adjust for different diameter cables and/or different lateral positioning of cables as the extend through a seal module. To affix the jacket supports to the cable jacket, fasteners (e.g., threaded fasteners such as screws or bolts) are inserted through holes 869 of the supports 861 and corresponding holes 868 defined by the main body 858 to tighten and fix the previously slidable supports 861 to the jacket 843.

The strength rod fixation portion 862 includes two sets of tracks 870, 871, either of which can accommodate the strength rod anchoring subassembly 862 for anchoring the strength rod 841. Thus, one of two positions along the axis 853 can be selected for the subassembly 862, which can improve the versatility of the assembly 850 to accommodate strength rods that extend from the end of the cable jacket by different lengths. Sliding engagement of the subassembly 862 with respect to either set of tracks 870, 871 is consistent with corresponding description above.

Advantageously, the main body 858 defines a material void 872 on each side of an extension 873 that defines the strength rod subassembly tracks. That is, the extension 873 alone defines the distal most extent of the main body 858, with material voids 872 on either side. The material voids 872 can minimize snagging or other interference with optical fibers or sheaths carrying optical fibers as they extend distally beyond the end of the cable jacket on the rest of the organizer assembly beyond the distal end of the assembly 850.

The main body 858 defines a recess 874 with curved surface configured to match or approximately match the curvature of the jacket 843. Due to the large size of the cable, the multiple curved surfaces that hug the cable jacket, including the surface of the recess 874 and the curved surfaces of the jacket supports 861 can improve fixation of the cable.

For improved strength and robustness, the assembly 850 is configured to be secured to a receiver 816, optionally, with threaded fasteners. The fasteners 875 are inserted through posts 877 extending from the main body 858 and cooperate with threaded retainers 876 and projections 878 defined by the receiver 816 to securely mount the assembly 850 to a receiver 816, with each retainer 876 abutting a side of a projection 878 that faces the same direction as the fastener insertion direction, as shown in FIG. 46.

Alternatively, feet 880 of the main body 858 can be inserted in footholds of the receiver 816, and catches of flexibly resilient tabs 881 (or of other structures, such as T-shaped projections) of the receiver 816 can enter and slide through T-shaped openings 882 to lockingly mount the assembly 850 to the receiver 816.

The hose clamp 1000 can be used to secure an electrical grounding component or assembly (not shown) to the cable shield.

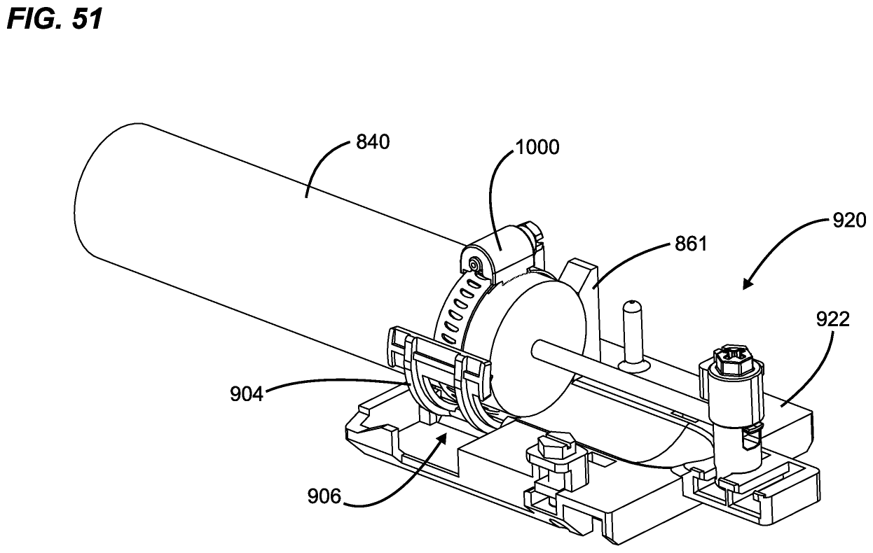

FIG. 49 is a perspective view of a further example cable fixation assembly 900 according to the present disclosure. FIG. 50 is an exploded view of the assembly of FIG. 49.

Referring to FIGS. 49-50, the assembly 900 includes a main body 902. Like the assembly 850, the assembly 900 has a main body 902 that includes the material voids, the curved recess, multiple sets of tracks for strength member fixation subassemblies, and in addition, the assembly can be made of metal and includes fasteners and threaded retainers. In this example, rather than the sliding jacket supports 861, the jacket of the cable 840 is secured with a pair of pivoting clamp pieces 904 that pivotally mount to receivers 906 defined by the main body 902. The pivoting nature of the pieces 904 allows the clamping action to be adjusted to different cable sizes and lateral positions of the cable. Each clamp piece includes teeth 910 that can dig into the cable jacket

The hose clamp 1000 can be used to secure an electrical grounding component or assembly (not shown) to the cable shield.

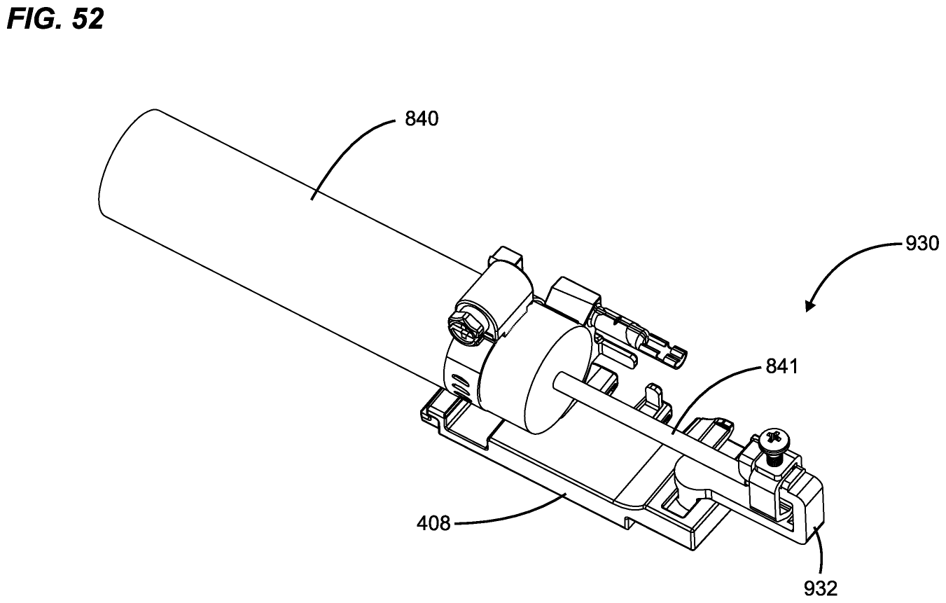

FIG. 51 is a perspective view of a further example cable fixation assembly according 920 according to the present disclosure. The assembly 900 includes a main body 922. Like the assembly 850, the assembly 920 has a main body 92 that includes the material voids, the curved recess, multiple sets of tracks for strength member fixation subassemblies, and in addition, the assembly can be made of metal and includes fasteners and threaded retainers. In this example, rather than a pair of sliding jacket supports 861, the jacket of the cable 840 is secured with one slidable jacket support 861 (and accompanying fastener) and an opposing pivoting clamp piece 904 that pivotally mounts to a receiver 906 defined by the main body 922. Coupling of the jacket support 861 and the piece 904 to the main body 922 is as described above. The pivoting nature of the piece 904 together with the sliding nature of the jacket support 861 allows the clamping action to be adjusted to different cable sizes and lateral positions of the cable.

The hose clamp 1000 can be used to secure an electrical grounding component or assembly (not shown) to the cable shield.

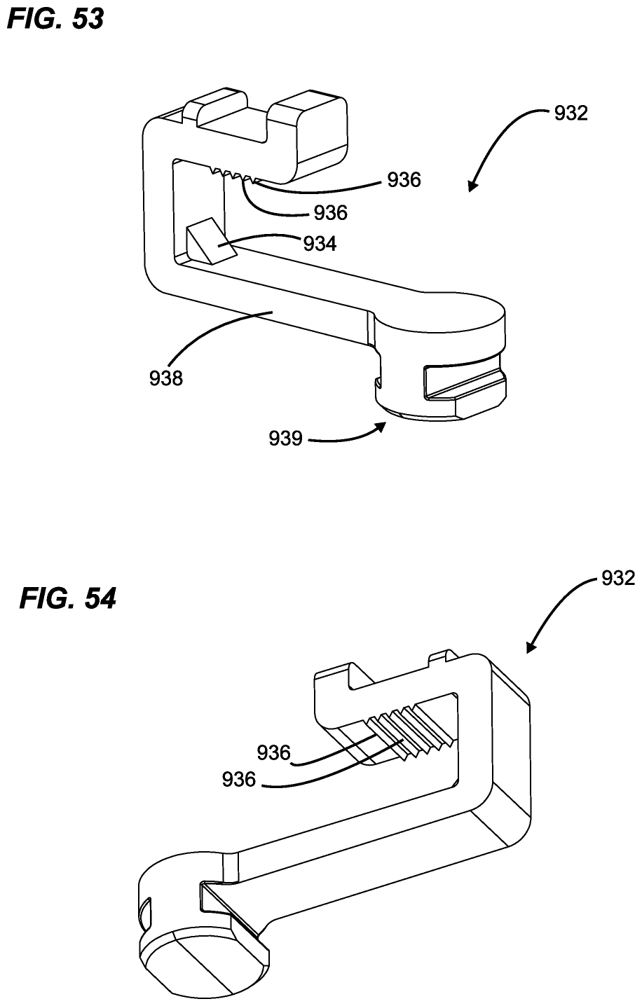

FIG. 52 is a perspective view of a further example cable fixation assembly 930 according to the present disclosure. FIG. 53 a perspective view of the strength member clamp body 932 of the assembly of FIG. 52. FIG. 54 is a further perspective view of the strength member clamp body 932 of FIG. 53.

Referring to FIGS. 52-54, the assembly 930 is identical to the assembly 400 described above, except for the strength member clamp body 932. The strength member clamp body 932 includes a distally extending extension arm 938 extending distally away from the portion 939 that mounts to the tracks of the main body 408, such that the body 932 can accommodate a longer strength rod. In addition, the body 932 includes a ramp 934 to facilitate tightening of the other clamp parts to the strength rod. In addition, the body 932 includes teeth 936 configured to dig into a jacket of a strength rod for improved fixation, as some strength rods can include outer jackets made from a relatively soft material.

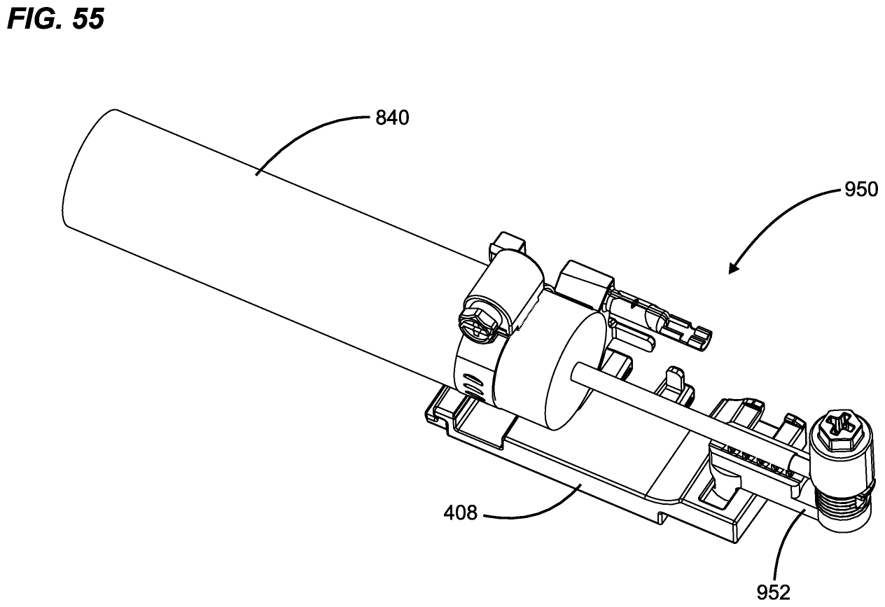

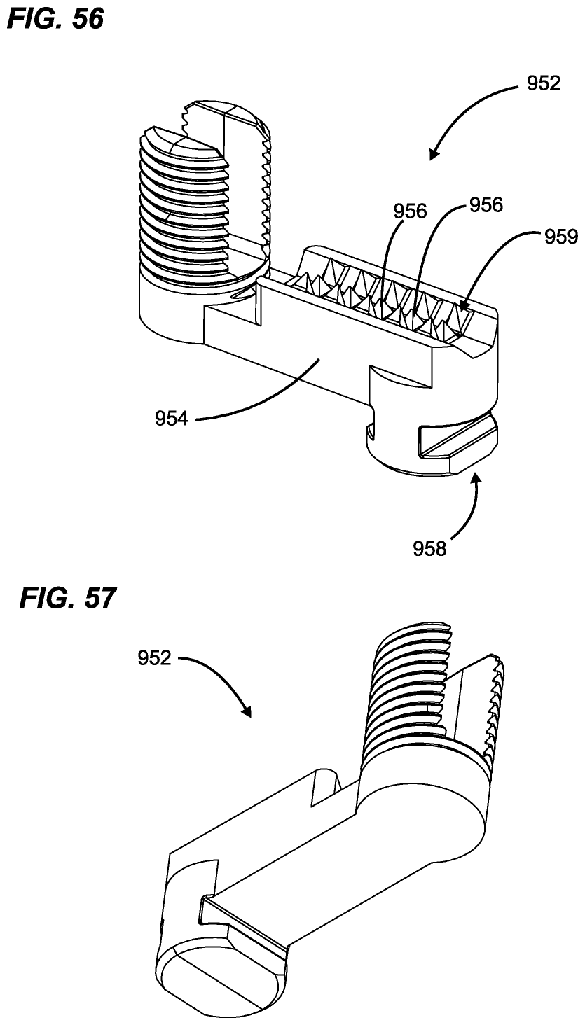

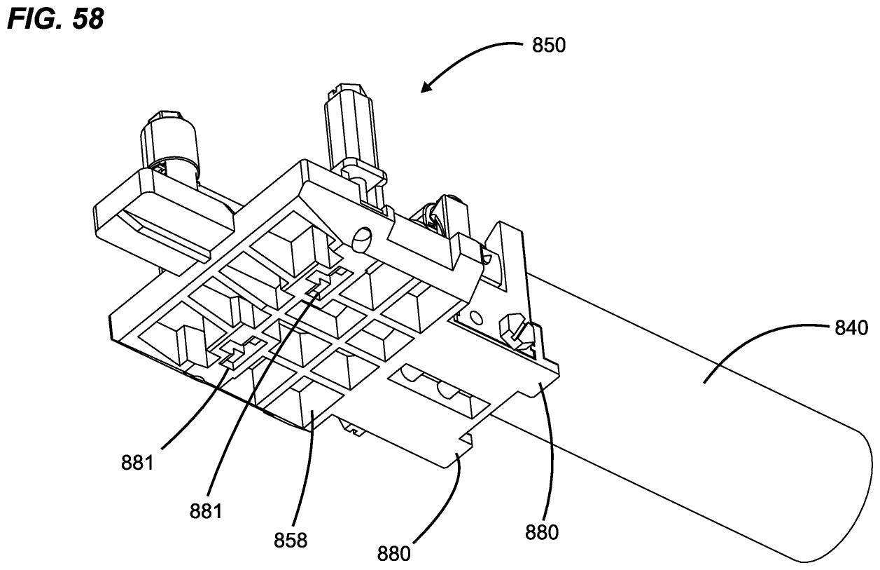

FIG. 55 is a perspective view of a further example cable fixation assembly 950 according to the present disclosure. FIG. 56 a perspective view of the strength member clamp body 952 of the assembly of FIG. 55. FIG. 57 is a further perspective view of the strength member clamp body 952 of FIG. 53.

Referring to FIGS. 55-57, the assembly 950 is identical to the assembly 400 described above, except for the strength member clamp body 952. The strength member clamp body 952 includes a distally extending extension arm 954 extending distally away from the portion 958 that mounts to the tracks of the main body 408, such that the body 952 can accommodate a longer strength rod. In addition, the body 952 includes teeth 956 positioned in a distally extending channel 959 of the arm 954, the teeth 956 being configured to dig into a jacket of a strength rod for improved fixation, as some strength rods can include outer jackets made from a relatively soft material.

Referring to FIGS. 44-45, each receiver 816 is also configured to lockingly receive a carrier adapter 310. Without a carrier adapter 310, the receiver 816 is configured to receive and mount a cable fixation assembly 850, 900, 920, 930, designed for large cables. A carrier adapter 310 is configured to lockingly support one or more smaller cable fixation assemblies. By mounting the carrier adapter 310 to a receiver 816, the receiver 816 is thereby adapted for supporting fixation assemblies for smaller cables. Thus, the carrier adapter 310 enables selective conversion of any of the receivers 816 of the first base piece 810 between different sized cables and different configurations of cable fixation subassemblies.

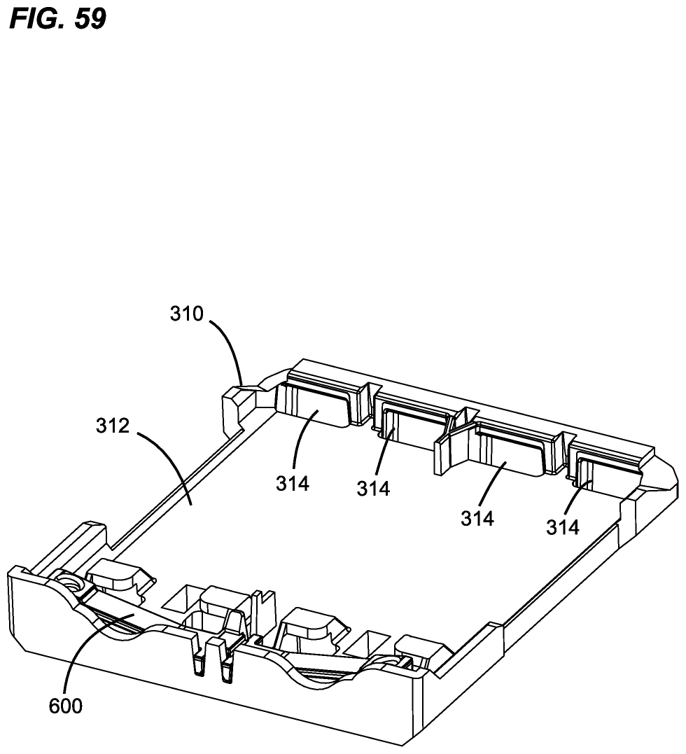

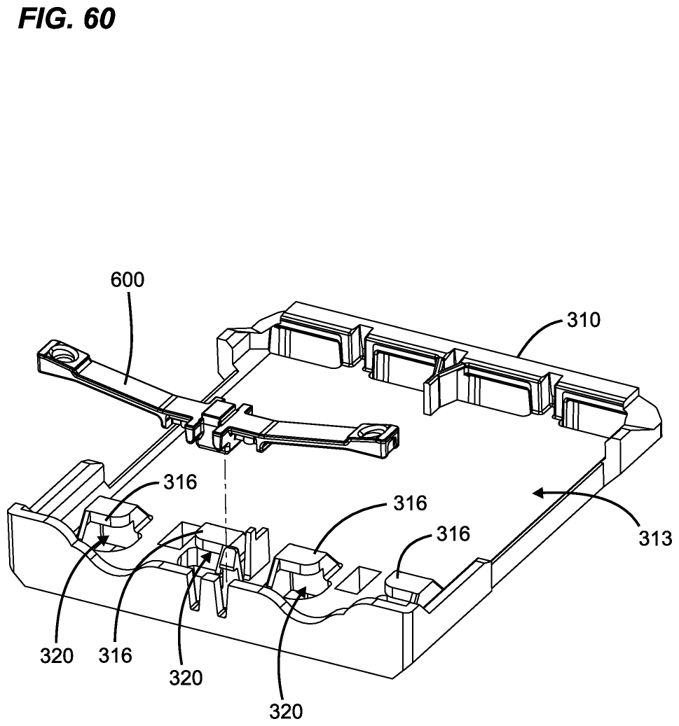

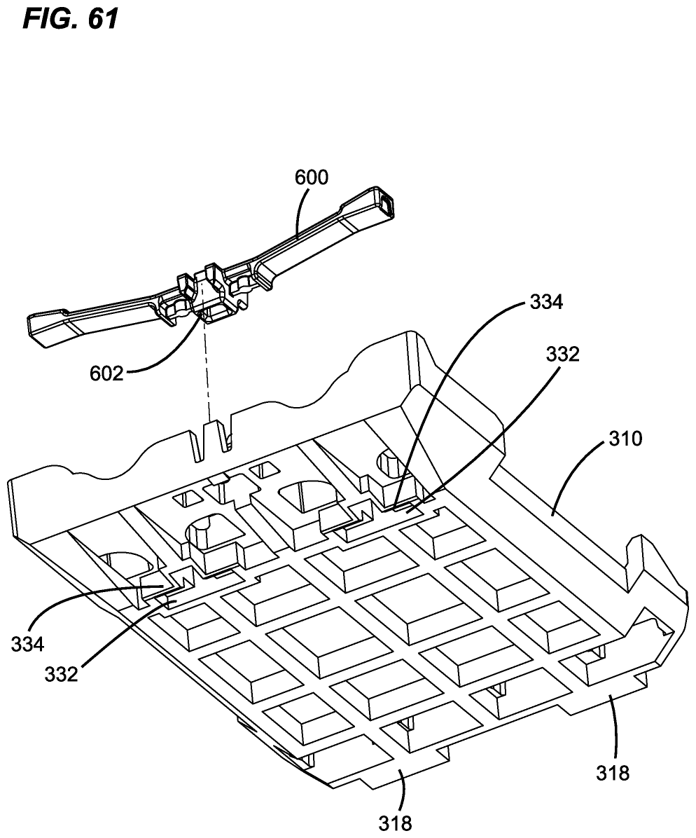

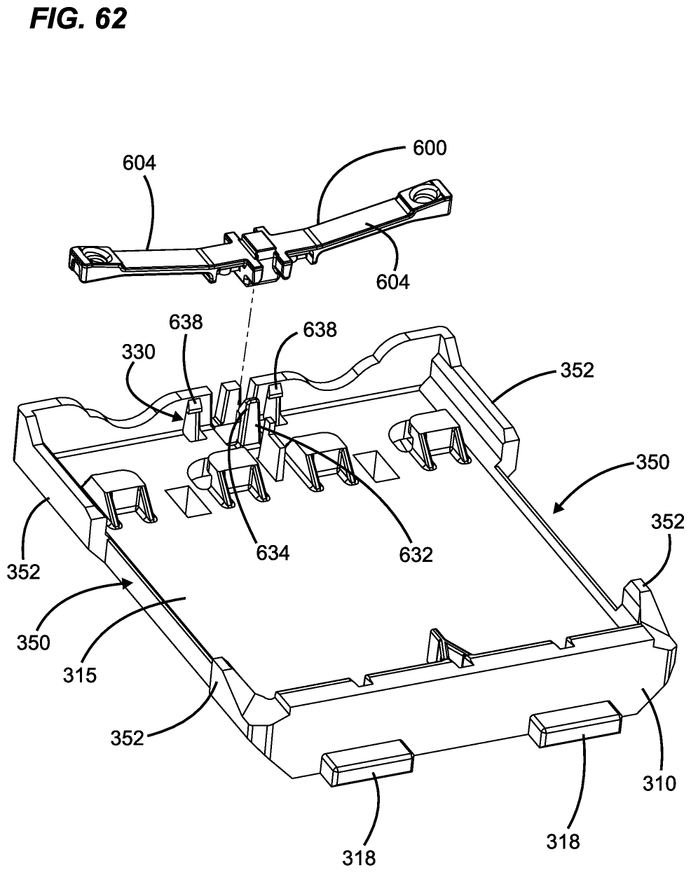

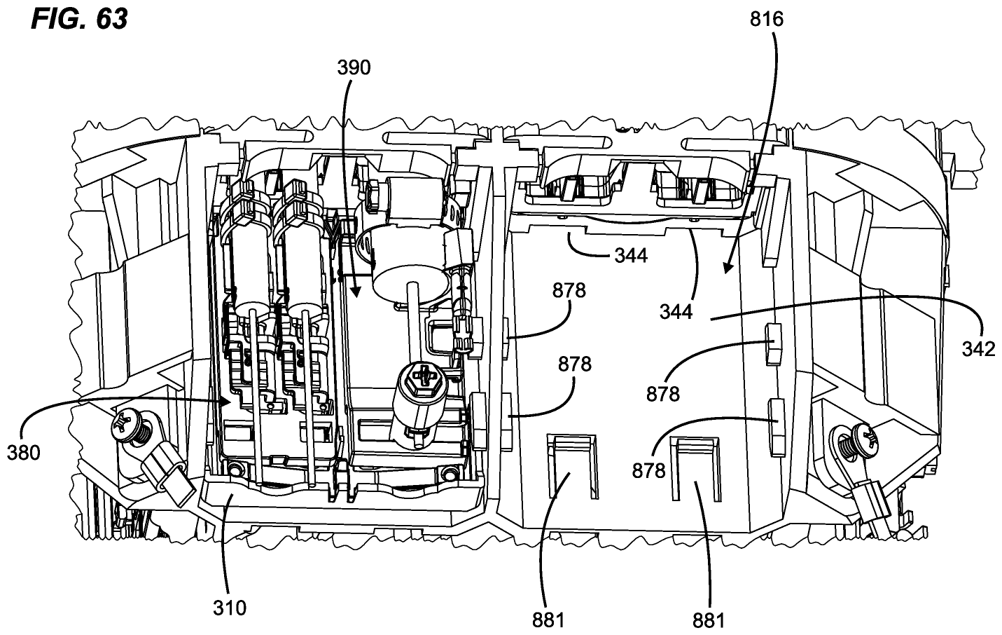

Referring to FIGS. 59-63, the carrier adapter 310 includes a body 312 that defines a receiving volume 313 for receiving and lockingly mounting cable fixation subassemblies, such as the subassemblies 380 and 390. The body 312 includes a main mounting surface 315, and defines footholds 314 and mounting structures 316.

To mount a baseplate of a cable fixation subassembly to the surface 315, proximal feet of the baseplate are slid into the footholds 314, while distal foot structures of the baseplate are slid into pockets 320 defined by the mounting structure 316, thereby securing the baseplate from movement in all directions except distal movement. To prevent distal movement, the body 312 includes an interface 330 that receives by snap-connection a module retainer 600. In particular the interface 300 includes structures 632 and 636, and catches 634 and 636 for receiving and mounting the central body 602 of the module retainer 600 by snap-connection, as described above. The arms 604 of the module retainer 600 are configured to prevent distal movement of the cable fixation subassembly installed on the carrier adapter 310. To remove a cable fixation subassembly, the corresponding arm 604 can be pressed to flex it to allow the baseplate of the cable fixation subassembly to distally clear the module retainer 600.

According to an example method, one or more cable fixation assemblies (e.g., including pre-fixed cables) are mounted to the surface 315 by engaging the feet of the baseplate with corresponding structures of the carrier adapter 310, following which the module retainer 600 is installed on the carrier adapter 310, following which the assembly of the carrier adapter 310, the module retainer 600 and the one or more cable fixation assemblies is mounted in a receiver 816.

The body 312 includes feet 318, slots 332 and shoulders 334. To mount the carrier adapter 310 to a receiver 816, the carrier adapter 310 is slid in a direction 340 along the surface 342 of the receiver 816 until the feet 318 enter footholds 344 defined by the receiver 816, the projections 878 of the receiver 818 are positioned to engage side walls 352 of the body 312, and/or one or more of the projections 878 are positioned in or aligned with reduced wall portions 350 of the side walls 352 of the body 312, and the catches of the tabs 881 snap into the slots 332, thereby inhibiting motion of the carrier adapter 310 within the receiver 816 in all directions.

As needed, the carrier adapter 310 can be unlocked and removed from a receiver 816 and replaced with another component, such as a cable fixation assembly 850, 900, 920, 930.

From the foregoing detailed description, it will be evident that modifications and variations can be made in the devices of the disclosure without departing from the spirit or scope of the invention.

What is claimed is:

1. An assembly for an organizer of a telecommunications closure, comprising:
a main support structure defining back-to-back first and second fixation surfaces, the first cable fixation surface being configured to directly mount a main body of a fixation assembly for a first cable, the main body including a cable jacket fixation portion;
a first baseplate, the first baseplate being configured to directly mount to the first cable fixation surface, the first baseplate being configured to directly mount a fixation assembly of a second cable having a smaller maximum transverse diameter than a maximum transverse diameter of the first cable; and
a second baseplate configured differently from the first baseplate, the second baseplate being configured to directly mount to the second cable fixation surface, the second baseplate being configured to directly mount the fixation assembly of the second cable.

2. The assembly of claim 1, wherein each of the first baseplate and the second baseplate defines slots for receiving hook members of a cable support body of the fixation assembly of the second cable.

3. The assembly of any of claims 1-2,
wherein the main support structure defines a stop wall extending away from the second cable fixation surface; and
wherein the stop wall is configured to prevent disengagement of the second baseplate from the second cable fixation surface.

4. The assembly of claim 3, wherein the main support structure defines footholds that receive spaced apart feet of the second baseplate when the second baseplate is secured to the second cable fixation surface.

5. The assembly of any of claims 1-4, further comprising:
a module retainer, the module retainer including a central body configured to snappingly mount to the main support structure, and first and second flexibly resilient arms extending from the central body and away from each other to free ends of the flexibly resilient arms, the flexibly resilient arms being configured to inhibit movement relative to the first cable fixation surface of the first baseplate when the first baseplate is secured to the first cable fixation surface.

6. The assembly of claim 5, wherein each of the flexibly resilient arms is configured to inhibit movement of a module when the module is mounted to the first cable fixation surface, the module being selected from the first baseplate and the main body of the fixation assembly for a cable.

7. The assembly of claim 5,
wherein the module retainer is mounted to the main support structure;
wherein the first baseplate is mounted to the first cable fixation surface and inhibited by one of the arms of the module retainer; and
wherein the main body of the fixation assembly for a cable is mounted to the first cable fixation surface and inhibited by the other of the arms of the module retainer.

8. A method, comprising:
providing the assembly of claim 3; and
bending the second baseplate to cause the second baseplate to lockingly engage the second cable fixation surface.

9. A method, comprising:
providing the assembly of any of claims 5-7; and
snap-fitting the module retainer to the main support structure such that a catch of the main support structure snaps over a surface of the central portion of the module retainer.

10. The method of claim 9, further comprising:
after the snap-fitting, flexing one of the arms;
while flexing one of the arms, inserting feet of a module into footholds defined by the main support structure, the module being selected from the first baseplate and the main body of the fixation assembly for a cable; and
after inserting the feet, releasing the flexed arm to secure the module to the first cable fixation surface.

11. The method of claim 10, further comprising,
after the releasing, flexing the one of the arms again; and
while flexing the one of the arms again, sliding the module to remove the feet from the footholds.

12. The method of any of claims 10-11, wherein each flexing includes positioning an end of a tool in a recess defined by the one of the arms.

13. The method of claim 12, wherein the tool includes a fiber pick.

14. A module retainer for retaining a cable fixation module relative to a main support structure of an organizer of a telecommunications closure, comprising:
a body configured to snappingly mount to the main support structure; and
a first flexibly resilient arm extending from the body to a free end of the first flexibly resilient arm.

15. The module retainer of claim 14, further comprising:
a second flexibly resilient arm extending away from the body and away from the first flexibly resilient arm to a free end of the second flexibly resilient arm.

16. The module retainer of any of claims 14-15, wherein the module retainer is of molded unitary construction.

17. The module retainer of claim 15,
wherein the body includes reinforcement ribs; and
wherein a fixed end of each of the flexibility resilient arms is positioned at one of the reinforcement ribs.

18. The module retainer of any of claims 15 and 17, wherein each flexibly resilient arm defines a recess configured to receive a tool for flexing the arm.

19. The module retainer of any of claims 14-18, wherein the body defines sockets configured to receive alignment structures of the main support structure.

20. An assembly for an organizer of a telecommunications closure, comprising:
a main body, the main body extending from a proximal end to a distal end along an axis defined by the main body, the main body including a cable jacket fixation portion, the cable jacket fixation portion including a shoulder defining a proximally facing surface configured to engage a distal end of an outer jacket of a cable when the cable is being secured to the cable jacket fixation portion with a longitudinal axis of the cable parallel to the axis defined by the main body, the shoulder and the surface being curved continuously at an outer edge from one end of the shoulder to an opposite end of the shoulder.

21. The assembly of claim 20, wherein a curvature of the shoulder corresponds to a curvature of a cable jacket of a cable secured to the main body.

22. The assembly of any of claims 20-21, wherein the cable jacket fixation portion includes projecting teeth configured to dig into the cable jacket, the teeth being of multiple sizes.

23. An assembly for an organizer of a telecommunications closure, comprising:
a main body, the main body extending from a proximal end to a distal end along an axis defined by the main body, the main body including a cable jacket fixation portion and a strength rod fixation portion; and
a strength member fixation subassembly, the main body defining a track, the subassembly being configured to slidably engage the track in a direction perpendicular to the axis, the main body further comprising a lip positioned at an open end of the track, the lip being configured to inhibit disengagement of the subassembly from the track.

24. The assembly of claim 23, wherein the main body defines first and second tracks, the subassembly being configured to slidably engage the tracks in a direction perpendicular to the axis, the main body further comprising a lip positioned at an open end of each of the tracks, the lips being configured to inhibit disengagement of the subassembly from the tracks.

25. The assembly of claim 24, wherein the subassembly includes a strength rod stopper extending distally from a member of the subassembly, the stopper including a proximally facing surface configured to inhibit distal growth or creepage of a strength rod of a cable having an outer jacket secured to the cable jacket fixation portion.

26. The assembly of claim 24, wherein the stopper is L-shaped.

27. The assembly of any of claims 23-26, wherein the cable jacket fixation portion includes a shoulder defining a proximally facing surface configured to engage a distal end of an outer jacket of a cable when the cable is being secured to the cable jacket fixation portion with a longitudinal axis of the cable parallel to the axis defined by the main body.

28. An assembly for an organizer of a telecommunications closure, comprising:
a main body, the main body extending from a proximal end to a distal end along an axis defined by the main body, the main body including a cable jacket fixation portion, the cable jacket fixation portion defining a pocket configured to receive and retain overlength of a strap of a cable clamp used to clamp a cable jacket to the cable jacket fixation portion.

29. The assembly of claim 28, further comprising a cable and a cable clamp clamping a jacket of the cable to the cable jacket fixation portion, the cable clamp including a strap, an overlength portion of the strap being positioned in the pocket.

30. The assembly of any of claims 28-29, wherein the pocket is defined by portions of surfaces of a recess defined by the main body, and a pair of opposing shoulders.

31. The assembly of claim 30, wherein the opposing shoulders are spaced apart from each other along the axis.

32. The assembly of claim 31, wherein the opposing shoulders define a gap therebetween, a maximum width of the gap parallel to the axis being less than a transverse width of the strap.

33. The assembly of any of claims 31-32, wherein each shoulder includes a ramped surface leading into the pocket from a portion of the recess that is outside the pocket.

34. The assembly of any of claims 28-33,
wherein the cable jacket fixation portion includes another shoulder defining a proximally facing surface configured to engage a distal end of an outer jacket of a cable when the cable is being secured to the cable jacket fixation portion with the cable clamp and with a longitudinal axis of the cable parallel to the axis defined by the main body.

35. The assembly of any of claims 28-34,
wherein the main body includes a strength rod fixation portion, the assembly further comprising:
a strength member fixation subassembly, the main body defining a track, the subassembly being configured to slidably engage the track in a direction perpendicular to the axis, the main body further comprising a lip positioned at an open end of the track, the lip being configured to inhibit disengagement of the subassembly from the track.

36. A telecommunications closure, comprising:
housing pieces configured to cooperate to define a sealable and re-enterable closure volume; and
the assembly of any of claims 1-7 and 20-35 positioned in the closure volume.

37. The closure of claim 36, further comprising:
cable seal blocks supported by one or more of the housing pieces; and
a feeder cable and a drop cable entering the closure volume through sealed ports defined by the seal blocks.

38. An assembly for an organizer of a telecommunications closure, comprising:
a main body, the main body extending from a proximal end to a distal end along an axis defined by the main body, the main body including a cable jacket fixation portion and an arrangement of posts and a notch for winding strength yarn of a cable, each of the posts projecting from a fixed end of the post to a free end of the post, the notch being located in an arm of a cable jacket support structure of the cable jacket fixation portion.

39. The assembly of claim 38, wherein the arrangement includes four of the posts.

40. The assembly of any of claims 38-39, wherein the notch has an open end at a proximal end of the main body and extends proximally to a closed end of the notch.

41. The assembly of any of claims 38-40, wherein the cable jacket fixation portion includes a shoulder defining a proximally facing surface configured to engage a distal end of an outer jacket of a cable when the cable is being secured to the cable jacket fixation portion with a longitudinal axis of the cable parallel to the axis defined by the main body.

42. The assembly of any of claims 38-41,
wherein the main body includes a strength rod fixation portion, the assembly further including:
a strength member fixation subassembly, the main body defining a track, the subassembly being configured to slidably engage the track in a direction perpendicular to the axis, the main body further comprising a lip positioned at an open end of the track, the lip being configured to inhibit disengagement of the subassembly from the track.

43. The assembly of any of claims 38-42, wherein the cable jacket fixation portion defines a pocket configured to receive and retain overlength of a strap of a cable clamp used to clamp a cable jacket to the cable jacket fixation portion.

44. A method, comprising:
winding a strength yarn of a cable around all of the posts and through the notch of the arrangement of any of claims 38-43.

45. A method, comprising:
providing a main body extending from a proximal end to a distal end along an axis defined by the main body, the main body including a cable jacket fixation portion and a strength yam winding arrangement, the arrangement including a post and a notch, the notch being located in an arm of a cable jacket support structure of the cable jacket fixation portion;
grasping strength yarn of a telecommunications cable; and
wrapping the yarn about the arrangement, including:
routing the yarn about the post, followed by;
routing the yarn through the notch; and
after the wrapping, clamping a remainder of the yarn and the cable to the main body with a cable clamp.

46. A method, comprising:
providing a main body extending from a proximal end to a distal end along an axis defined by the main body, the main body including a cable jacket fixation portion and a strength yam winding arrangement, the arrangement including a first post, a second post, a third post, a fourth post, and a notch, the notch being located in an arm of a cable jacket support structure of the cable jacket fixation portion;
grasping strength yam of a telecommunications cable; and
wrapping the yam about the arrangement, including:
routing the yarn in front of the first post, followed by;
routing the yarn behind the second post, followed by;
routing the yarn behind the third post, followed by;
routing the yarn behind the fourth post, followed by;
routing the yarn behind the second post, followed by;
routing the yarn behind the first post, followed by;
routing the yarn through the notch; and
after the wrapping, clamping a remainder of the yarn and the cable to the main body with a cable clamp.

47. The assembly of claim 1, wherein each of the first baseplate and the second baseplate includes a cantilever at a slot, each cantilever being molded of uniform construction with the corresponding baseplate, each cantilever being configured to resiliently flex to mount a fixation assembly of a cable to the corresponding baseplate, and to resiliently return to an unflexed configuration to lock the fixation assembly of the cable to the corresponding baseplate.

48. The assembly of claim 47, wherein the cantilevers are configured differently from each other.

49. The assembly of any of claims 47-48, wherein the cantilever of the first baseplate is L-shaped.

50. The assembly of claim 49, wherein the cantilever of the first baseplate defines a depression configured to receive a tool for flexing the cantilever of the first baseplate.

51. An assembly for an organizer of a telecommunications closure, comprising:
a main body, the main body extending from a proximal end to a distal end along an axis defined by the main body, the main body including a cable jacket fixation portion for fixing a portion of a cable jacket; and
a jacket support that slidingly engages with the main body perpendicular to the axis to adjustably clamp to the cable jacket.

52. The assembly of claim 51, further comprising another jacket support that aligns with and opposes the jacket support and slidingly engages with the main body perpendicular to the axis to adjustably clamp to the cable jacket.

53. The assembly of claim 51, further comprising a fastener that fastens the jacket support to the main body.

54. The assembly of claim 52, further comprising fasteners that fasten the jacket supports to the main body.

55. The assembly of any of claims 53-54, wherein each fastener is inserted into the main body in a direction parallel to a direction in which each jacket support slidingly engages the main body.

56. The assembly of claim 51, further comprising a clamp piece pivotally mounted to the main body and opposing the jacket support to adjustably clamp to the cable jacket.

57. An assembly for an organizer of a telecommunications closure, comprising:
a main body, the main body extending from a proximal end to a distal end along an axis defined by the main body, the main body including a cable jacket fixation portion for fixing a portion of a cable jacket;
a clamp piece pivotally mounted to the main body; and
another clamp piece pivotally mounted to the main body and aligned with and opposing the clamp piece, the clamp piece and the another clamp piece being configured to pivot toward and away from each other to adjustably clamp to the cable jacket.

58. An assembly for an organizer of a telecommunications closure, comprising:
a main body, the main body extending from a proximal end to a distal end along an axis defined by the main body, the main body including a cable jacket fixation portion for fixing a portion of a cable jacket;
a threaded fastener; and
a threaded retainer, the main body being configured to be secured to a receiver of the closure by inserting the fastener through the main body and threading the fastener through the retainer to cause a portion of the main body to be clamped between the retainer and a projecting structure of the receiver.

59. The assembly of claim 58, wherein the main body is constructed of metal.

60. An assembly for an organizer of a telecommunications closure, comprising:
a main body, the main body extending from a proximal end to a distal end along an axis defined by the main body, the main body including a cable jacket fixation portion for fixing a cable jacket and a strength rod fixation portion positioned distally of the cable jacket fixation portion for fixing a cable strength rod,
wherein the strength rod fixation portion extends distally beyond a distal extreme of the main body, such that the main body defines material voids on three sides of the strength rod fixation portion.

61. An assembly for an organizer of a telecommunications closure, comprising:
a main body, the main body extending from a proximal end to a distal end along an axis defined by the main body, the main body including a cable jacket fixation portion for fixing a cable jacket and a strength rod fixation portion positioned distally of the cable jacket fixation portion for fixing a cable strength rod,
wherein the strength rod fixation portion includes multiple tracks defining at least a proximal location and a distal location positioned distally of the proximal location to which a strength member fixation subassembly can be slidably mounted.

62. The assembly of any of claims 51-61, further comprising a strength rod fixation body including an extension arm extending distally away from a portion of the strength rod fixation body that mounts to the main body.

63. The assembly of claim 62, wherein the strength rod fixation body includes teeth for digging into an outer jacket of a strength rod.

64. The assembly of any of claims 62-63, wherein the strength rod fixation body includes a ramped surface to guide a strength rod.

65. The assembly of any of claims 51-64, wherein the main body defines a curved recess to accommodate a curvature of the cable jacket.

66. A method, comprising:
fixing a jacket of a cable carrying an optical fiber to a cable jacket fixation body;
fixing the cable jacket fixation body to a baseplate and, thereafter:
mounting the baseplate to a surface of an assembly of a telecommunications closure, including bending the baseplate into a bent configuration and, while the baseplate is in the bent configuration, sliding the baseplate relative to the surface, such that mounting features of the baseplate engage mounting features projecting from the surface; and
releasing the baseplate such that the baseplate resiliently returns to an unbent configuration, thereby installing the baseplate on the assembly.

67. The method of claim 66,
wherein a stop wall projects from the surface; and
wherein the stop wall is configured to prevent disengagement of the baseplate from the surface when the baseplate is installed on the assembly.

68. A method, comprising:
fixing a jacket of a cable carrying an optical fiber to a cable jacket fixation body;
mounting the cable jacket fixation body to a surface of a carrier adapter;
mounting a retainer to the carrier adapter, the retainer including a retainer body and a flexibly resilient arm extending from the retainer body to a free end of the flexibly resilient arm such that the retainer arm prevents disengagement of the cable jacket fixation body from the surface of the carrier adapter and, thereafter;
mounting the carrier adapter to a receiver of an assembly of a telecommunications closure.

69. The method of claim 68, wherein mounting the carrier adapter to the receiver increases a number of fixed cables that can be accommodated by the receiver.

70. An assembly for an organizer of a telecommunications closure, comprising:
a carrier adapter, the carrier adapter configured to receive a cable jacket fixation body and further configured to mount in a receiver of an assembly of a telecommunications closure; and
a retainer, the retainer including a retainer body and a flexibly resilient arm extending from the retainer body to a free end of the flexibly resilient arm, the retainer body being configured to snap-connect to the carrier adapter such that the retainer arm prevents disengagement of the cable jacket fixation body from the surface of the carrier adapter.

71. The assembly of claim 70,
wherein the retainer includes another flexibly resilient arm extending away from the retainer body and away from the flexibly resilient arm to a free end of the another flexibly resilient arm.

72. The assembly of claim 70,
wherein the carrier adapter is configured to receive two cable jacket fixation bodies side by side.

73. The assembly of any of claims 70-72, wherein the carrier adapter is configured to increase a number of fixed cables that can be accommodated by the receiver.
